(19) United States
(12) Patent Application Publication
(10) Pub. No.: US 2002/0059100 A1
(43) Pub. Date: May 16, 2002

(54) Apparatus, systems and methods for customer specific receipt advertising

(76) Inventor: Jon Shore, Conifer, CO (US)

Correspondence Address: Khorsandi Patent Law Group, A Law Corporation, Suite 312, 140 S. Lake Ave., Pasadena, CA, 91101-4710, US

(21) Appl. No.: 09/960,899

(22) Filed: Sep. 21, 2001

Related U.S. Application Data
(60) Provisional application No. 60/234,623, filed on Sep. 22, 2000.
(60) Provisional application No. 60/255,981, filed on Dec. 15, 2000.

(51) Int. Cl. G06F 17/60

(52) U.S. Cl. 705/14

(57) ABSTRACT

The present invention (sometimes referred to herein as Customer Specific Receipt Advertising (“CSRA”)) will provide apparatus, systems and methods that will provide participating retailers and service providers the ability to offer coupons, advertising and communications on printed or electronic receipts such that the coupons are specifically oriented towards the customer's buying habits and needs. Customers can choose to be included, or not to be included, in this program when establishing their account with Immtec's mewallet™ system, or any credit or debit card provider. The customer can also sign up for this service with any participating, licensed merchant.

### CROSS-REFERENCE TO RELATED APPLICATIONS

This application claims priority to U.S. Provisional Patent Application Ser. No. 60/234,623 (“Apparatus, Systems and Methods for Customer Specific Receipt Advertising”) filed Sep. 22, 2000, and No. 60/255,981 (“Apparatus, Systems and Methods for Customer Specific Receipt Advertising”) filed Dec. 15, 2000, the disclosures of which are incorporated herein in full for all purposes as if fully stated here. The disclosures of U.S. Provisional Patent Application Ser. No. 60/181,600 filed Feb. 10, 2000, No. 60/187,924, filed Mar. 8, 2000, No. 60/255,980, filed Dec. 15, 2000, and Int'l. Application No. PCT/US01/04258, Int'l Filing Date Feb. 9, 2001 are incorporated herein in full for all purposes as if fully stated here.

### SUMMARY OF THE INVENTION

The present invention (sometimes referred to herein as Customer Specific Receipt Advertising (“CSRA”)) will provide apparatus, systems and methods that will provide participating retailers and service providers the ability to offer coupons, advertising, promotional offers, and communications on printed or electronic receipts such that the coupons are specifically oriented towards each particular customer's buying habits, preferences and needs. At the same time, in the exemplary embodiment of the invention, each customer's buying habits, preferences and needs could be kept confidential from the knowledge of individual vendors.

With the present invention, Customers would be able to choose to be included, or not to be included, in this program when establishing their account with Immtec's mewallet™ system, or other CSRA-enabled credit or debit card provider. The customer could also sign up for this service with any participating, licensed merchant.

Consumer data would be kept on secure Immtec servers. The CSRA back-end software would reside on the Immtec servers as well. CSRA interface software could be licensed to retailers, organizations, banks, manufacturers, wholesalers, advertising companies, marketing companies and credit/debit card providers. CSRA data would not be sold to other providers under any circumstances.

### BRIEF DESCRIPTION OF THE DRAWINGS

These and other features of the present invention are more fully set forth in the following description of exemplary embodiments of the invention. The description is presented with reference to the accompanying drawings in which:

FIG. 1 is a high level flow diagram depicting a customer sign-up procedure in an exemplary embodiment of the present invention;

FIG. 2 is a high level flow diagram depicting an Internet-based procedure for a customer to change customer use preferences in an exemplary embodiment of the present invention;

FIG. 3 is a high level flow diagram depicting a telephone-based procedure for a customer to change customer use preferences in an exemplary embodiment of the present invention;

FIGS. 4-6 provide a high level flow diagram depicting an authorized-service-center-based procedure for a customer to change customer use preferences in an exemplary embodiment of the present invention;

FIGS. 7-8 provide a high level flow diagram depicting customer specific receipt advertising processing functions in an exemplary embodiment of the present invention;

FIG. 9 is a high level flow diagram depicting an Internet-based vendor log-in interface in an exemplary embodiment of the present invention;

FIG. 10 is a high level flow diagram depicting an Internet-based vendor new offer upload process in an exemplary embodiment of the present invention;

FIG. 11 is a high level flow diagram depicting an Internet-based vendor offer edit process in an exemplary embodiment of the present invention;

FIG. 12 is a high level flow diagram depicting an Internet-based vendor offer delete process in an exemplary embodiment of the present invention;

FIG. 13 is a high level flow diagram depicting an Internet-based vendor logo upload process in an exemplary embodiment of the present invention;

FIG. 14 is a high level flow diagram depicting an Internet-based vendor logo delete process in an exemplary embodiment of the present invention;

FIG. 15 is a high level flow diagram depicting an Internet-based vendor account update process in an exemplary embodiment of the present invention;

FIG. 16 is a high level flow diagram depicting an Internet-based view vendor account transaction data process in an exemplary embodiment of the present invention;

FIG. 17 is a high level flow diagram depicting an Internet-based vendor exit process in an exemplary embodiment of the present invention;

FIG. 18 is a high level flow diagram depicting a process in an exemplary embodiment of the present invention for transmitting a vendor offer from the system through a vendor point of service terminal to a customer handheld device;

FIG. 19 is a high level flow diagram depicting a process in an exemplary embodiment of the present invention for transmitting micro-credits from a vendor's micro-credit account in the system through a vendor point of service terminal to a customer handheld device;

FIGS. 20-21 provide a high level flow diagram depicting a process in an exemplary embodiment of the present invention for a customer to redeem an approval-required vendor offer using a system-enabled customer handheld device;

FIG. 22 is a high level flow diagram depicting a process in an exemplary embodiment of the present invention for a customer to redeem an no-approval-required vendor offer using a system-enabled customer handheld device;

FIGS. 23-26 provide a high level flow diagram depicting a process in an exemplary embodiment of the present invention for a customer to access a vendor's offers using a wireless-enabled customer handheld device through a vendor doorway-location terminal;

FIGS. 27-30 provide a high level flow diagram depicting a process in an exemplary embodiment of the present invention for a customer to access a vendor's offers using a wireless-enabled customer handheld device through a wireless Internet connection to the system of the present invention; and

FIG. 31 is a high level simplified graphic representation depicting high level software and data interfaces for customer access of vendor offers using a wireless-enabled handheld customer device through a wireless-enabled billboard or kiosk in an exemplary embodiment of the present invention.

### FACSIMILE REPRODUCTION OF COPYRIGHT MATERIAL

A portion of the disclosure of this patent document contains material, which may be subject to copyright protection by Immtec, Inc. or other rightful copyright owner. Immtec, Inc., or other rightful copyright owner, has no objection to the facsimile reproduction by anyone of the patent document or the patent disclosure, as it appears in the Patent and Trademark Office patent file or records, but otherwise reserves all copyright rights whatsoever.

Trademarks

Immtec™, Microwallet™, mewallet™, CSRA™, Customer Specific Receipt Advertising™, and PayStick™ are trademarks of Immtec, Inc. The names of actual companies and products mentioned herein may be the trademarks of their respective owners.

### DETAILED DESCRIPTION OF THE INVENTION

In an exemplary embodiment present invention, a wireless hand held device would be used by a consumer to access and redeem vendor offers. Wireless, hand held devices, include for example, wireless Personal Digital Assistants (“PDAs”), wireless telephones e.g., cellular telephones, and wireless electronic authority and cash transfer devices, an exemplary embodiment of which is sometimes referred to as a PayStick™. In an exemplary embodiment of the present invention, the wireless hand held device would comprise a memory storage device for storing data, an executable memory, a computer device, such as a microprocessor, and short-range wireless communication hardware such as an infrared transceiver or Bluetooth radio transceiver, and related communication software and/or firmware. In some exemplary embodiments, the wireless hand held device would provide a display screen on which information text, numbers and/or graphics can be displayed.

The CSRA Program

In an exemplary embodiment of the present invention, when a new customer establishes an account with Immtec™ for the mewallet™ system, they would be offered the CSRA service. If the new customer chooses to be a part of this service, they would be asked a series of questions regarding what areas of commerce in which they would like to be included and the level of anonymity they would prefer. In the exemplary embodiment of the invention, Microwallet™ credits (also sometimes referred to herein as “coupons”) would be provided by service providers and retailers who choose to participate in the CSRA program. If a mewallet™ customer chooses not to participate in the CSRA program, then their customer mewallet™ data would reflect this choice and they would not receive advertising, offers or information based on their profile in the Immtec™ database. They may receive printed receipt advertising, but these advertisements or offers would not be generated based on the customer's data in the Immtec™ system. Customers would be able to, at any time, change their preferences for the CSRA program (also sometimes referred to herein simply as the “system” or the “System”).

Signing up for the CSRA Program

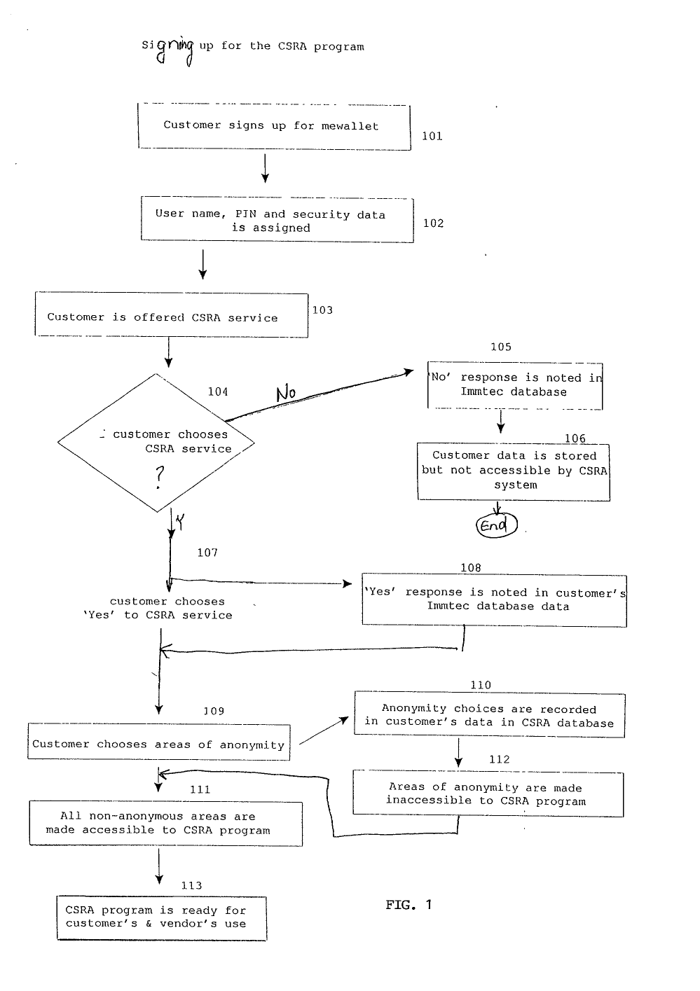

Customer sign-up procedures for the CSRA program are described below in an exemplary embodiment of the present invention and are depicted in FIG. 1. In the exemplary embodiment of the present invention, the CSRA system would be operable to perform in the following manner:

Each customer would sign-up for the Immtec mewallet™ system on the Internet or at a licensed service provider 101. Each Customer would be given a user name and PIN, (Personal Identification Number) 102. The customer would be offered a description of the CSRA service 103 and would be given an opportunity to participate or not participate 104. If the customer chooses not to participation in the CSRA program: the Customer would check the ‘No’ option for the choice offered to participate in the CSRA program and a ‘No’ response would be noted in customer's file in the Immtec database 105; and the Customer's data would be stored but would not be accessible by the CSRA system or any other service provider 106. (As previously noted, Customer data would not be sold for any reason whatsoever).

If the customer chooses to participate 107 in the CSRA program: the customer would check ‘Yes’ for the choice offered to participate in the CSRA program and a ‘Yes’ response is noted in the customer's file in the Immtec database 108; and the system continues processing.

The Customer would then be offered a number of choices regarding areas of commerce in which the user could choose to participate or not participate (remain anonymous) 109. The Customer's choices of areas of anonymity are recorded in the data corresponding to the particular Customer in the Immtec database 110. Areas of anonymity chosen by each customer are made inaccessible to the CSRA system 112. All other areas of a Customer's data are made accessible to the CSRA system 111.

At this point, the CSRA system would be ready for the particular Customer's use 113.

Changing Data use Preferences

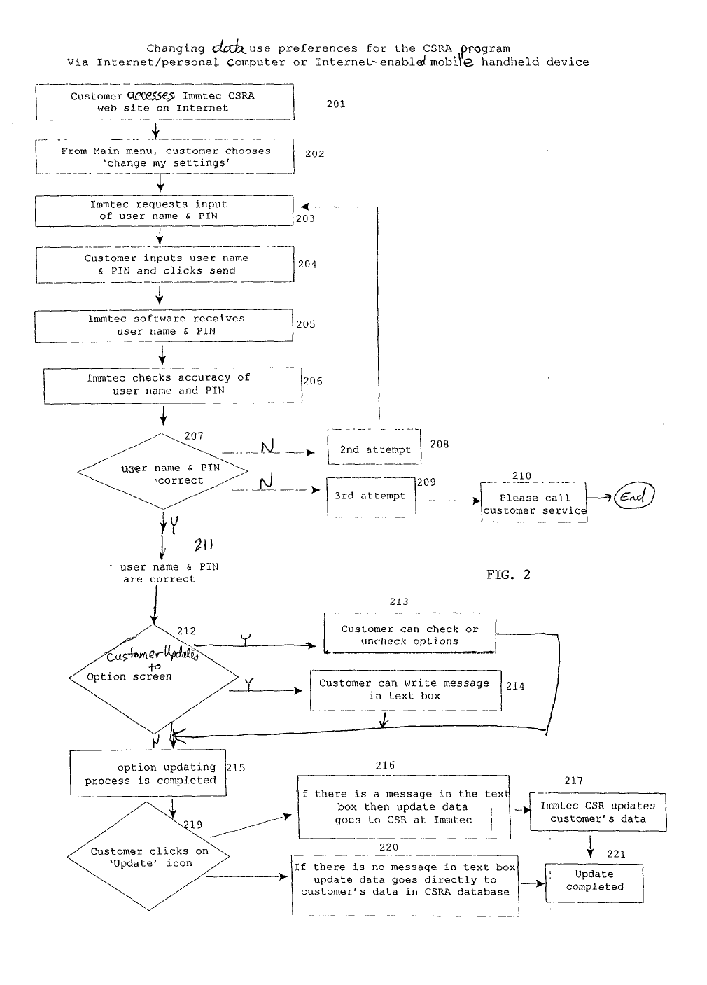

The process for a customer to change their data use preference settings, via the Internet, utilizing a personal computer or Internet-enabled mobile device, for the CSRA program is described below in the exemplary embodiment and is depicted in FIG. 2.

In the exemplary embodiment of the present invention, in order to change the Customer's data use preferences, a Customer would access the Immtec CSRA web site 201. The Customer would choose ‘Change my settings’ 202. The system screen would display a request for user name and PIN 203.

The Customer would then enter the Customer's user name and PIN 204 (In one alternative exemplary embodiment, a biometric-reader-interface-enabled-computer or mobile device would be provided such that biometric data would replace the PIN).

The system sever would receive the user name and PIN and would compare the received information with data in the customer database of the system 205-207. If on the first attempt, the user name and/or PIN are incorrect 208, the Customer would be asked to input correct user name and PIN 203. If user name and PIN are incorrect on the second attempt, the Customer would be asked to call System customer service 210.

If user name and PIN are correct 211, the System would display an Option screen and the Customer would be given an opportunity to update the Customer's options 212. If the Customer chooses to update options, the Customer could check or uncheck options 213 and could add text message to CSRA program 214. When the Customer's option updating is complete 215, the Customer could then click on an ‘Update’ button 219 and updated use preference data is transmitted to Immtec's CSRA database center. If a text message has been included in use updates, then the use preference profile is updated by a Customer Service Representative (“CSR”) 216-217. If no text message is included in the update, then updated use preference data is transmitted to CSRA database, and Customer's data use profile is updated by CSRA software 220. At this point, the Customer's data use profile would be updated 221.

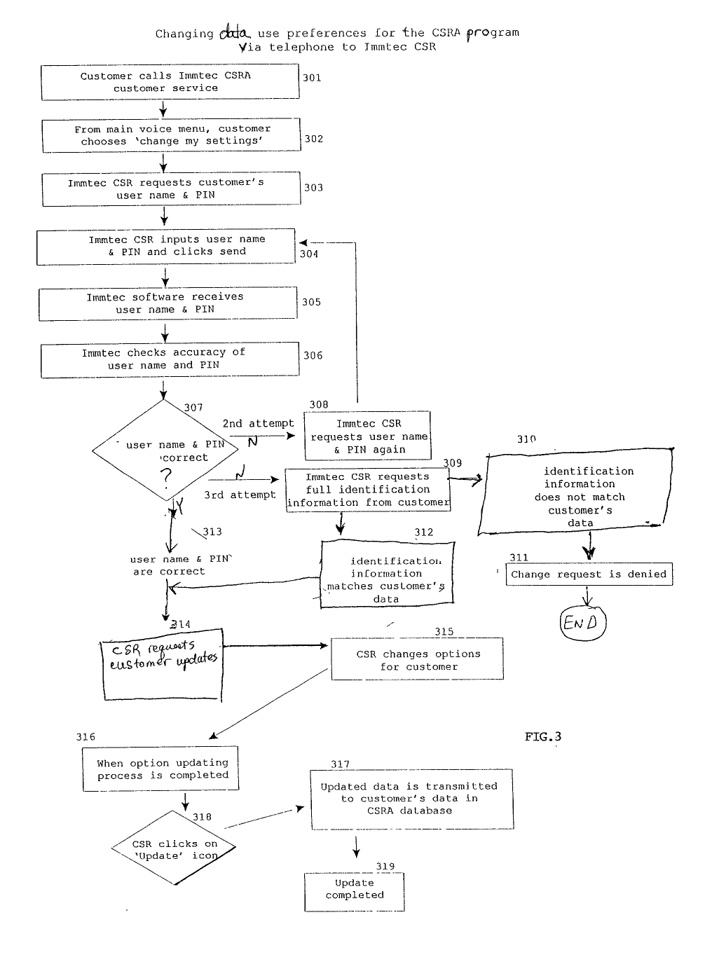

The process for the customer to change their data use preference settings, via telephone, for the CSRA program is described below in the exemplary embodiment and is depicted in FIG. 3.

In the exemplary embodiment of the present invention, the Customer would call Immtec CSRA customer service 301. The Customer chooses ‘Change my settings’ from the voice menu 302 and the Customer would be connected to a Customer Service Representative (“CSR”) at the Immtec CSRA program center. The CSR would request the Customer's user name and PIN 303. The CSR would input the user's name and PIN 304. The system would receive the input name and PIN 305 and would check the accuracy of the input 306-307. If the Customer's user name and PIN are incorrect, the CSR would request the user name and PIN again. If after the second try the name and PIN are incorrect, the CSR would request personal information to see if it matches information in Immtec's data base 309. If the personal information does not match 310, the Customer's request for access would be denied 311. If the personal information matches information in Immtec's database 312, then the CSR would input the correct user name and PIN so that the customer could continue with the update process. Once the user name and PIN are correct 313, the CSR would request the customer's desired changes 314. Once the Customer gives the CSR the desired changes, the CSR would enter the changes to the customer's data use profile 315. When the CSR has completed updating the Customer's options 316, the CSR would click on an “Update” icon 318. At that point, the system would update the customer's data in the CSRA database 317 and the update would be complete 319.

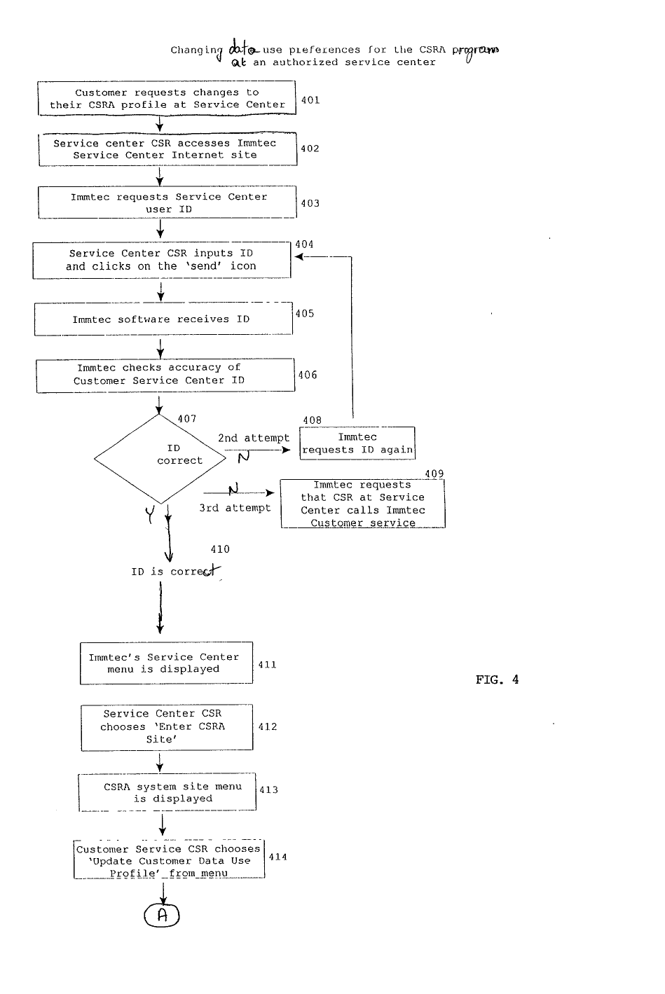

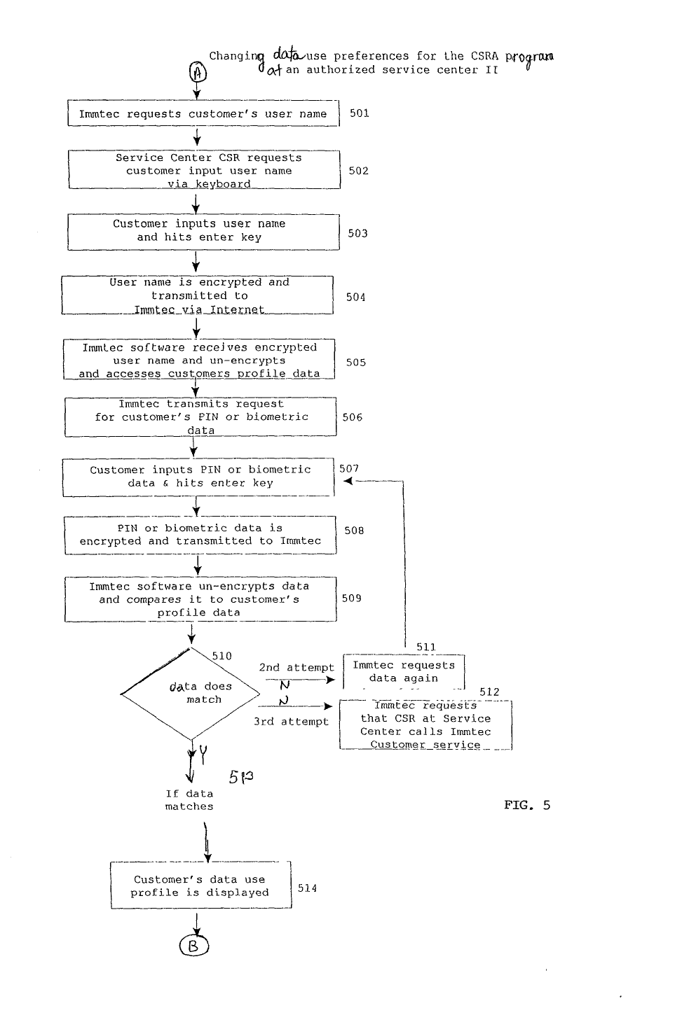

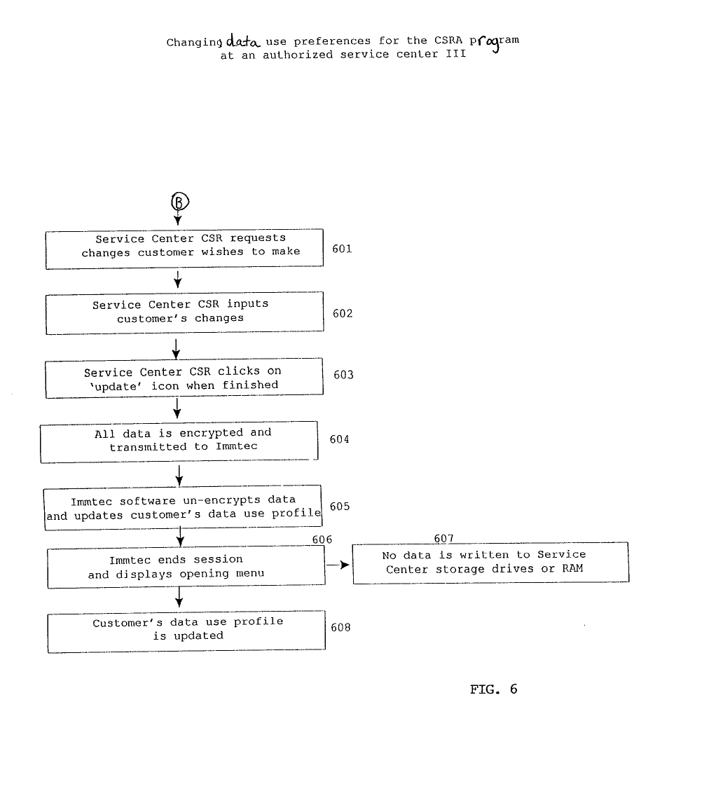

The process for the customer to change their data use preference settings, at an authorized service center, for the CSRA program is described below in the exemplary embodiment and as depicted in FIGS. 4, 5, and 6. Note that in an alternative embodiment with a biometric reader interface enabled computer at the Authorized service center, biometric data would replace the PIN.

At an authorized service center, the Customer would request changes be made to their CSRA profile settings 401. The Service center CSR would access a special Service Center Internet site 402. The Service Center Internet site would request the service center's user ID 403. The Service center CSR would input user ID and would click ‘send’ 404. The Service center user ID is transmitted to the system's (e.g., Immtec's CSRA) security middleware for accuracy checking 405-407.

If service center user ID is incorrect, the Service center CSR would be instructed to input user ID a second time 408. If after a third attempt the ID is not correct, the CSR would be instructed to call Immtec customer service 409. If service center user ID is correct 410, the CSRA/Immtec service center site menu would be displayed 411. The Service center CSR could choose ‘Enter CSRA site’ 412. The CSRA system site menu for authorized service centers would be displayed 413. The Service center CSR would choose ‘Update customer data use profile’ 414. The CSRA system would request a user name of customer profile to change 501. The Service center CSR would request that the customer input a user name 502. The Customer would input the Customer's user name 503. The Customer would then click the ‘enter’ key on the keyboard 503. The User name would then be transmitted to Immtec 504.

The CSRA system would accesss the customer's data in the customer database 505. The CSRA system would then request the customer's PIN or biometric data 506. The Customer would then input PIN or biometric data 507. The Customer would then click the ‘enter’ key on keyboard 507. The Customer's PIN would then be transmitted to the CSRA system 508. The CSRA system would compare transmitted PIN with PIN in database 509.

If the PIN does not match the PIN in the CSRA database on the first attempt, the system would request that the data be re-input 511. If the PIN is not correct after the third attempt, the system would instruct the Customer to contact customer service 512.

If user name and PIN are correct 513, the Customer's CSRA data use profile would be displayed 514.

The Service center CSR asks customer for desired changes to profile 601 and the Customer would tell the service center CSR the changes to make. The Service center CSR would input the desired changes 602. The Service center CSR would then click the ‘update’ button on the CSRA site screen 603. The system would then update the customer's data use profile in the CSRA customer database 604-605, 608.

At that point, the system would end the session and would display an opening menu 606 and no previous screens can be accessed by clicking on the browser's ‘back’ button. No data is written to the service center's hard drive 607.

How the CSRA System Works

The CSRA system collects, compiles and collates all use, purchasing and spending data from each CSRA-enabled handheld customer device (e.g., “mewallet™”). This data is stored on secure system (“Immtec”) servers. When a customer conducts a transaction using a mewallet™ device, the details of that transaction, including the amount, items purchased, method of payment used, date, time and location, are transmitted to the Immtec CSRA system and stored in the customer's data profile. The customer chooses what data, if any, is incorporated into the CSRA program. If the customer has chosen to participate in the CSRA program then the data that Immtec CSRA system collects is used to create a personalized use experience for the mewallet™ customer. Each time the mewallet™ device is used for a transaction with a POS device that is connected to the Immtec CSRA network via hardwire line or wireless, a printed or electronic advertisement, coupon, offer or other information, specifically oriented to the customer and vendor, is generated by the CSRA system to the POS and added to the merchant's or service provider's printed or electronic receipt. The term ‘offer’ refers to any coupon, information, advertisement or message generated by the CSRA system and transmitted for printing or transmission with a vendor receipt.

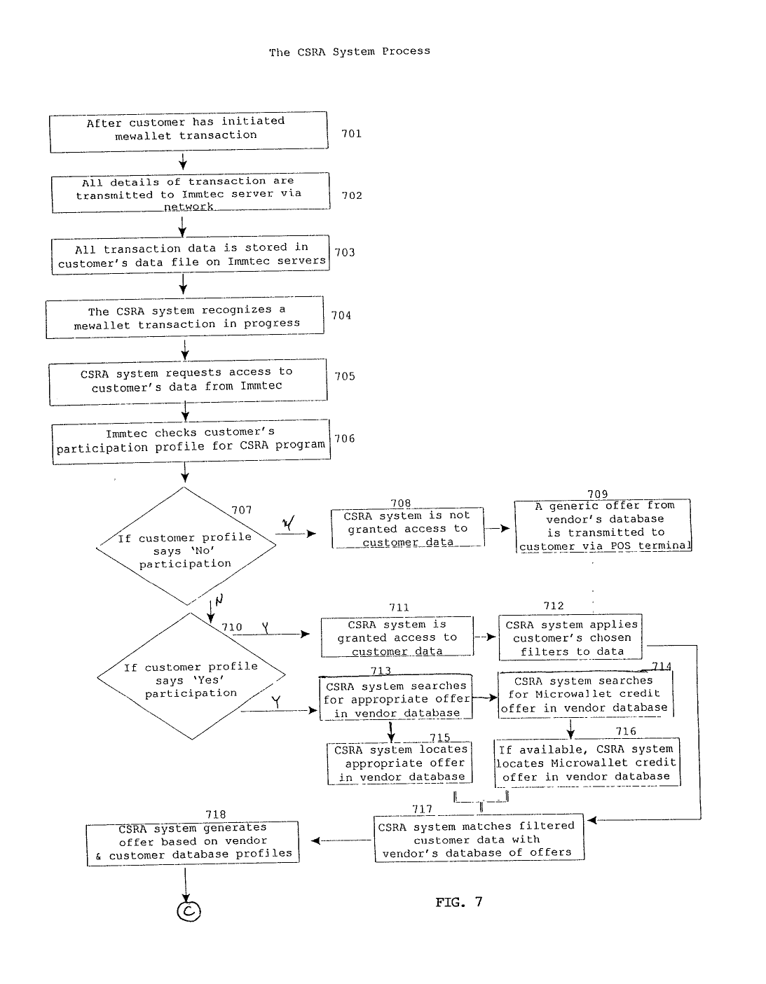

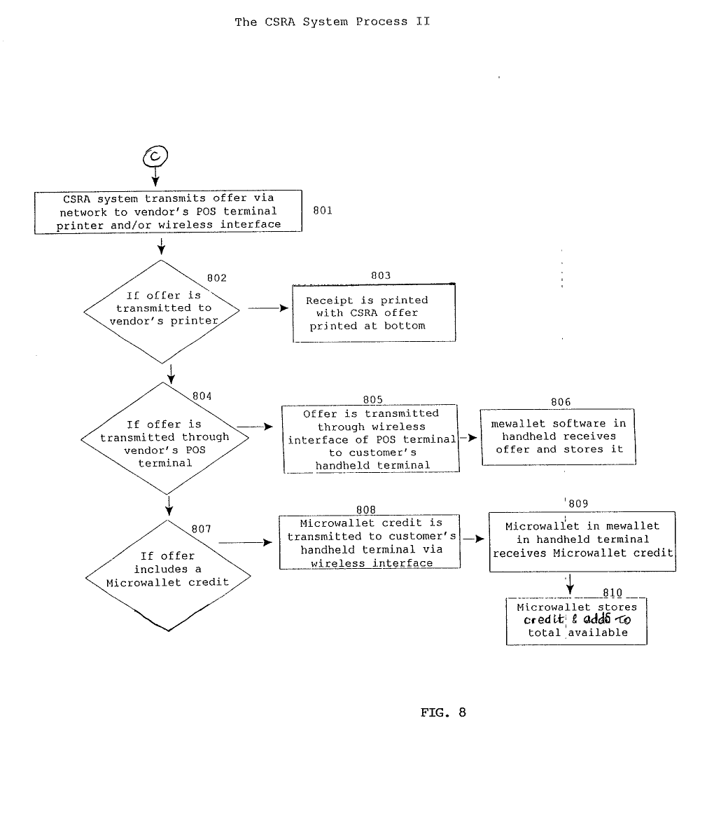

The CSRA system process as it would be implemented in the exemplary embodiment is described below and is depicted in FIGS. 7-8.

After customer has initiated mewallet™ transaction with a Vendor 701, all details of transaction data are transmitted to Immtec/CSRA servers (alternatively referred to herein as “Immtec” servers) 702. All details of transaction data are stored in customer's data file on Immtec servers 703.

The CSRA system recognizes each mewallet™ transaction in progress 704. The CSRA system requests permission of the Immtec database for access to customer's data 705.

Immtec checks the customer's participation profile for the CSRA program 706-707. If the customer has chosen not to participate in CSRA program, the CSRA system is not granted access to the customer's data in the Immtec database 708 and a generic offer, referencing the transaction vendor is transmitted for printing or electronic transmission with the receipt 709.

If the customer has chosen to participate in the CSRA program 710, the CSRA system is granted access to the customer's data 711. At that point, the CSRA system applies the customer's chosen filters to the transaction data 712. The CSRA system searches for appropriate receipt offer in the vendor's database 713. The CSRA system searches for microwallet credit offers in the vendor's database 714. The CSRA system locates appropriate offer from vendor in the vendor's database at Immtec 715. If available, the CSRA system locates appropriate Microwallet credits from the vendor's Microwallet credit account at Immtec 716.

The CSRA system matches data from the customer profile with offers in the vendor's database 717. The CSRA system generates an offer based upon customer and Vendor/merchant profiles 718. The CSRA system transmits one or more appropriate offers through the vendor's system to the vendor's receipt printer 801. If appropriate, the CSRA system transmits the appropriate Microwallet credit through the POS device to the customer's handheld device via infrared or other wireless method 808.

The mewallet™ software in the handheld device adds the Microwallet credit to the Microwallet amount in memory of the handheld device 809-810. As the vendor's/merchant's receipt printer completes printing, an appropriate receipt offer is added to the bottom of the printed receipt 803. If the offer is transmitted to the vendor's POS terminal, the offer is added to electronic receipt transmitted to the customer's handheld device via infrared or other wireless method 805-806.

Merchant Sign-up Process

A vendor could become a licensee of the CSRA program via the Internet at the Immtec web site, by calling the Immtec CSRA Merchant Services Center, by mailing in a CSRA licensee contract, or through a CSRA Merchant Services sales representative. A secure vendor account would include:

Vendor offers database

Microwallet credit offers account

Vendor data

Vendor logos in .bmp format

Access codes for updating vendor's data and uploading and deleting offers at the Immtec CSRA secure web site

Access to general mewallet™ sales, offers and Microwallet credits transmitted records, for vendor

Using the Vendor Immtec/CSRA Site

Using the features of the invention as it would be implemented in an exemplary embodiment, a vendor's offers can be created, deleted and edited at the Immtec/CSRA program offices and added to the vendor's CSRA database as an add on service. Offers can also be created, edited, deleted and uploaded to the CSRA database by vendors at any time. Vendor's are provided with web-based software templates and training for creating, editing, deleting and updating their offers. Vendor's can cross-market by creating alliance partnerships with other vendors. Offers from one vendor can be transmitted to receipts printed or transmitted electronically, to that vendor's alliance partner(s). Any offer sent through alliance partners requires a signed agreement between all participating alliance partners filed at Immtec. Once a signed agreement is filed, Immtec issues the alliance partners unique agreement codes for each offer. The offer uploaded must conform exactly to the agreement filed at Immtec.

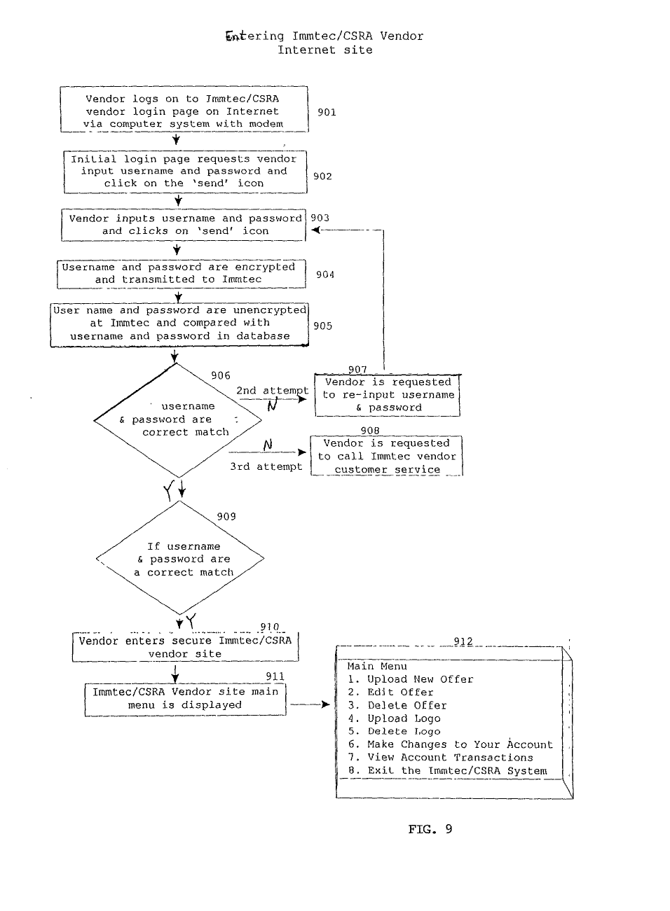

Using the vendor Immtec/CSRA site process as it would be implemented in an exemplary embodiment of the invention is described below in the exemplary embodiment and is depicted in FIGS. 9-17.

1. Entering the Vendor Immtec/CSRA Site

The entering vendor Immtec/CSRA site process as it would be implemented in an exemplary embodiment is described below and is depicted in FIG. 9.

A Vendor connects to Immtec/CSRA vendor login page on the Internet via computer system equipped with modem 901. On initial login page, Immtec requests vendor input username and password and click on the send button on the page 902.

The Vendor inputs username and password and clicks on the send button on the page 903. The Username and password are encrypted and transmitted to Immtec 904. The Username and password are unencrypted and compared with username and password in system database records 905-906.

The Vendor is given three attempts to input a correct username and password, 906-909. If after the third attempt, the input can not be validated, the Vendor is asked to call Immtec customer service 908.

If username and password are a correct match 909, the Vendor enters secure Immtec/CSRA vendor site 910. The CSRA vendor site menu screen is displayed 911. The Menu items include 912: 1.) Upload new offer; 2.) Edit offer; 3.) Delete offer; 4.) Upload logo; 5.) Delete logo; 6.) Make changes to account; 7.) View Account Transactions; 8.) Exit the Immtec/CSRA system.

2. Upload New Offer

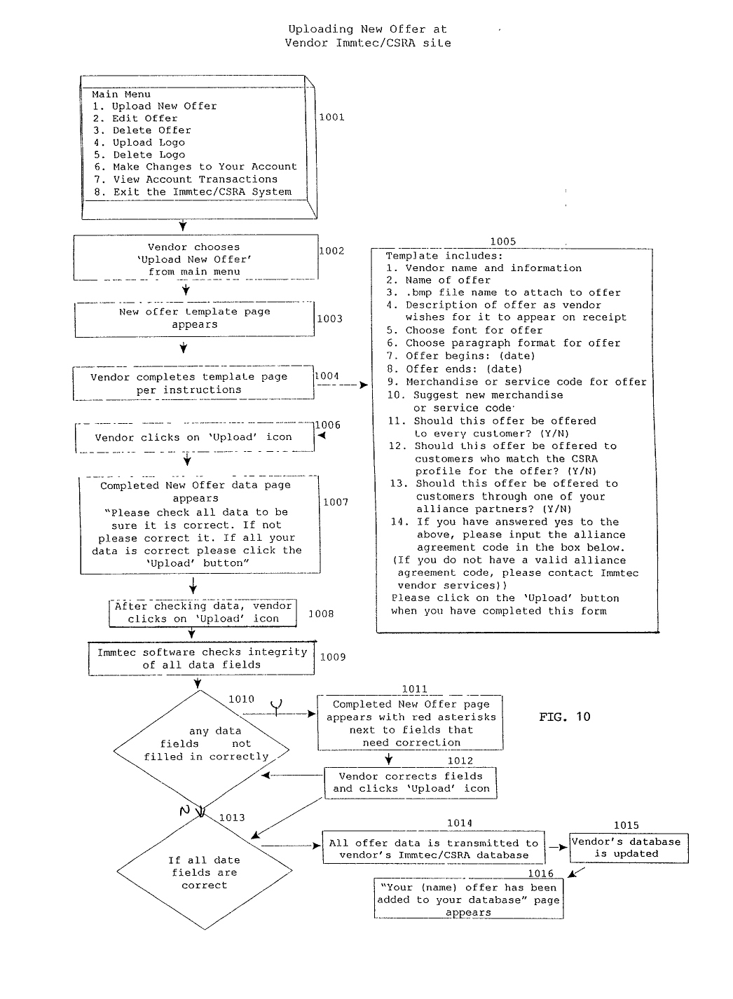

If a vendor chooses to ‘Upload new offer’ 1002 (depicted in FIG. 10 as the process would be implemented in an exemplary embodiment of the invention), a ‘New Offer’ page appears 1003. The ‘New offer’ page displays a template for a new offer 1005 which includes:

1. Vendor name and information.(these fields are automatically filled in but can be changed)

2. Name of offer

3. bmp file for offer to attach

4. Description of offer as vendor wishes it to appear on receipt

5. Choose font for offer

6. Choose paragraph format for offer

7. Offer begins: Date

8. Offer ends: Date

9. Merchandise or service code for offer

10. Suggest new merchandise or service code

11. Should this offer be offered to every customer? (Y/N)

12. Should this offer be offered to customers who match CSRA profile for the offer? (Y/N)

13. Should this offer be offered to customers through one of your alliance partners? (Y/N)

14. If you have answered yes, please input alliance agreement code in the box below

15. If you do not have a valid alliance agreement code, please contact Immtec customer service

16. Click on the ‘upload’ button when you have completed this form

When vendor clicks on the ‘upload’ button all form data is transmitted to the the vendor's CSRA database 1006-1014, the Vendor's offer database is updated 1015, and a message that “Your (name of vender) offer has been added to your database” is transmitted to vendor via Immtec/CSRA web site 1016.

3. Edit Offer

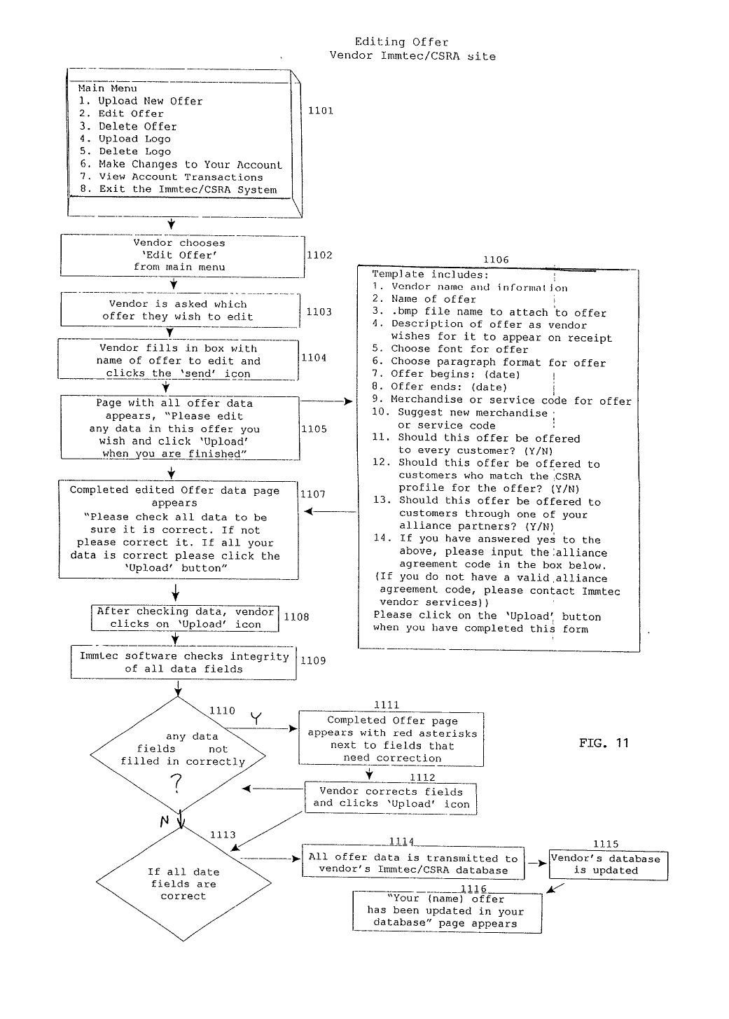

If the vendor chooses ‘Edit offer’ 1102 (as depicted in FIG. 11 as the process would be implemented in an exemplary embodiment of the invention), an ‘Edit Offer’ page appears asking the Vendor which offer they wish to edit 1103. The Vendor checks a box corresponding to the offer that vendor want to edit and clicks on ‘send’ button to transmit name of offer to edit 1104.

The Immtec/CSRA system receives the edit request and displays for the vendor a web page containing details about the offer 1105-1106, asking the Vendor to edit the offer data. Once the Vendor has edited the appropriate offer data, the Vendor clicks on an ‘Upload’ button 1108. The edited offer data is transmitted to the Immtec/CSRA system 1109-1114 and the Vendor's CSRA database information is updated 1115. A message that “Your (name of vendor) offer has been updated in your database” is transmitted to the vendor via the Immtec/CSRA web site 1116.

4. Delete Offer

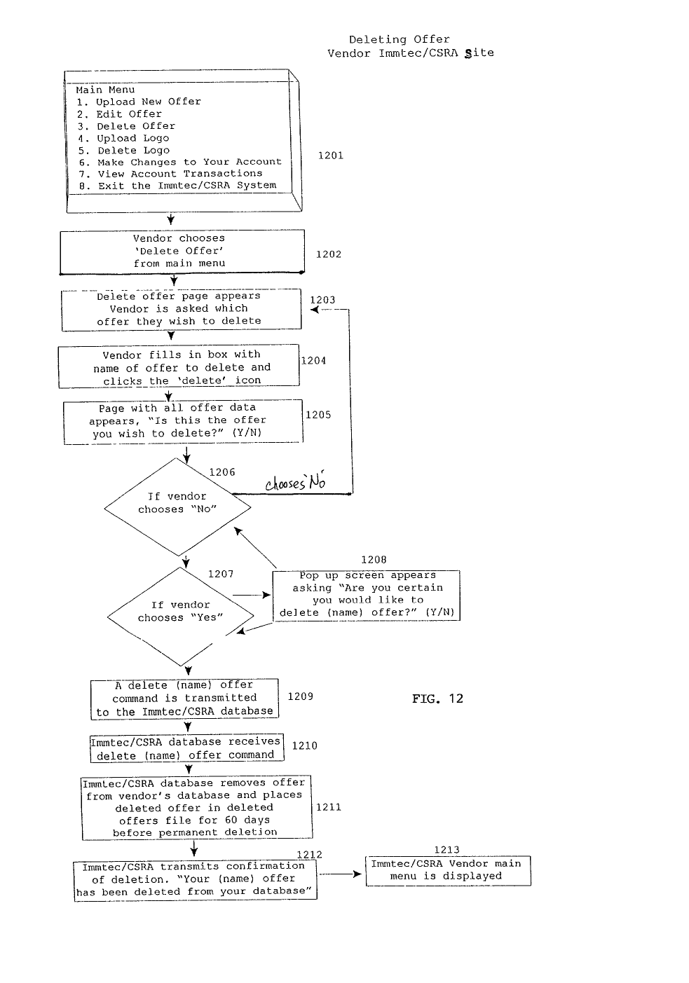

If vendor chooses ‘Delete offer’ 1202 (as depicted in FIG. 12 as the process would be implemented in an exemplary embodiment of the invention), a ‘Delete offer’ web page is displayed requesting the vendor to input an identification of the offer to be deleted 1203. The Vendor fills in a box corresponding to a name of the offer to be deleted and clicks on a ‘Delete’ button to transmit name of offer to be deleted 1204.

The Immtec/CSRA system receives the delete request, displays a web page containing information about the offer to be deleted and asks, “Is this the offer you wish to delete?” (Y/N) 1205.

If the vendor clicks on ‘No’ 1206, the ‘Delete offer’ screen is displayed again and vendor can begin the process again 1203-1205. If the vendor clicks on ‘Yes’ 1207, then a pop up screen appears asking, “Are you certain you would like to delete this (name) offer? (Y/N) 1208. If vendor clicks on ‘No’ 1206, the vendor is returned to ‘Delete offer’ page 1203. If the vendor clicks on ‘Yes’ 1207, then a delete (name) offer is transmitted to Immtec/CSRA database 1209.

The Immtec/CSRA database receives the delete (name) offer command 1210 and the Immtec/CSRA system deletes the identified offer from the vendor's offer records in the vendor database 1211. The Immtec/CSRA system transmits confirmation of the deletion 1212 that “Your (name) offer has been deleted from your database” to the vendor via the Immtec/CSRA web site 1212. At that point, the Immtec/CSRA main menu page is displayed 1213.

5. Upload Logo

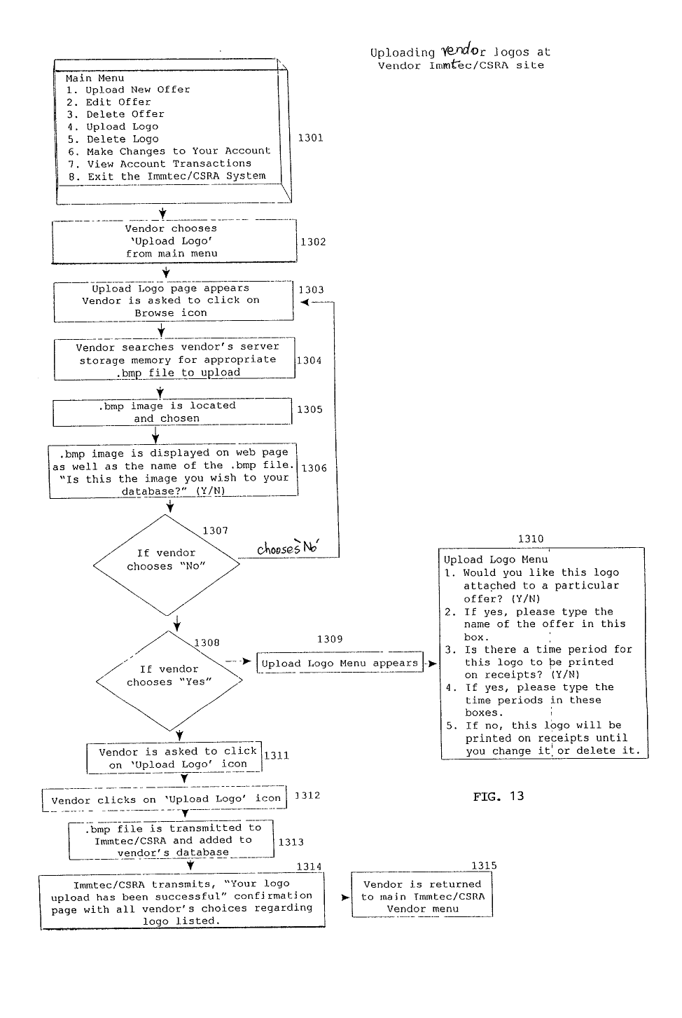

If vendor chooses ‘Upload logo’ 1302 from main menu (as depicted in FIG. 13 as the process would be implemented in an exemplary embodiment of the invention), an Upload logo dialog page is displayed prompting the vendor to click on a browse button 1303. If the vendor clicks on the browse button, the system searches the vendor's information in the vendor's server storage memory to locate a logo .bmp file corresponding to the vendor to upload 1304. If located, the .bmp file corresponding to the vendor is chosen 1305, and is displayed on a web page with the bitmap image of the vendor's logo 1306.

The Immtec/CSRA system prompts the vendor by asking “Is this the logo you wish to upload to your database?” (Y/N) 1306. If the vendor responds “No” 1307, the system restarts the Upload logo dialog page display and the process begins again 1303. If the vendor responds “Yes” 1308, the system prompts the vendor with questions that are then displayed with boxes for answers 1309-1310, including:

1. Would you like this logo attached to a particular offer? (Y/N)

2. If yes, please type the name of the offer in this box

3. Is there a time period for this logo to be printed receipts? (Y/N)

4. If yes, please type time period in these boxes

5. If no, this logo will be printed on receipts until you change it or delete it.

The Vendor is then asked to click on the ‘Upload Logo’ button 1311. The Vendor clicks on ‘Upload Logo’ button 1312. The .bmp file and data are transmitted and added to Immtec/CSRA the vendor's database 1313. The system then displays a message page that “Your logo upload has been successful” to confirm the upload for the vendor 1314.

6. Delete Logo

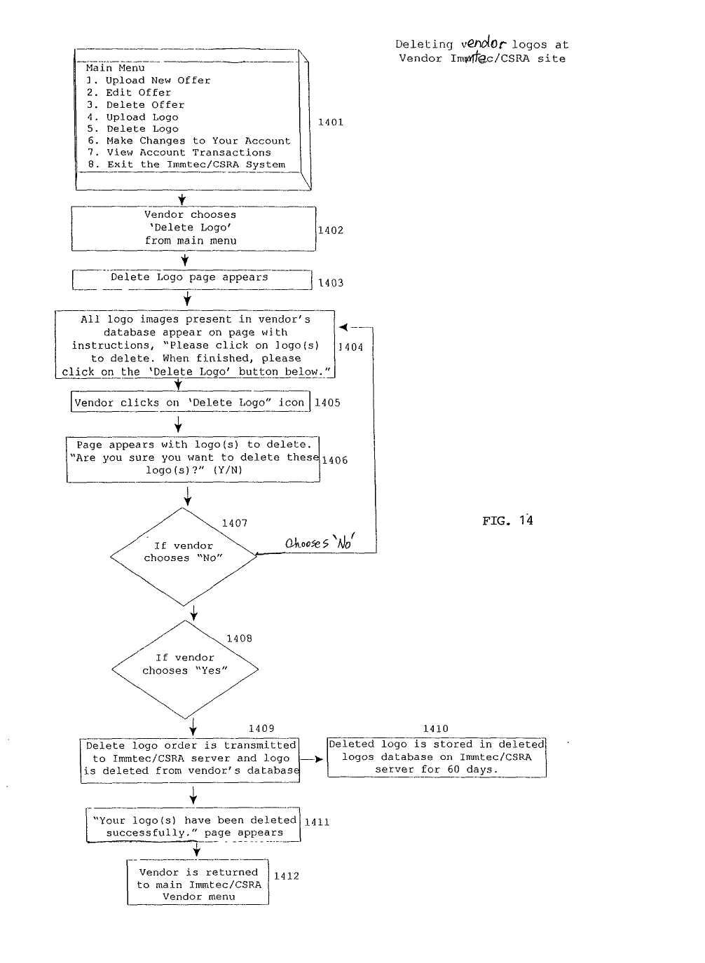

If the vendor chooses to ‘Delete Logo’ (as depicted in FIG. 14 as the process would be implemented in an exemplary embodiment of the invention) 1402:

a) a Delete logo page appears 1403.

b) All logos present in vendor's database appear on page with request: “Please click on logo(s) you would like to delete. When finished, please click on the ‘Delete Logo’ button below” 1404.

c) When vendor has completed choosing, ‘Delete Logo’ button is clicked 1405.

d) Page appears with logo(s) chosen for deletion 1406.

e) Are you sure you wish to delete these logos? (Y/N) buttons 1406.

f) If the vendor clicks on the ‘No’ button then initial Delete Logo screen appears again 1407.

g) If the vendor clicks on the ‘Yes’ button then the delete order is transmitted to the Immtec/CSRA vendor's database and logos are deleted 1408-1410.

h) “Your delete order has been completed” page appears 1411.

i) Initial menu screen appears 1412.

7. Making Changes to Account

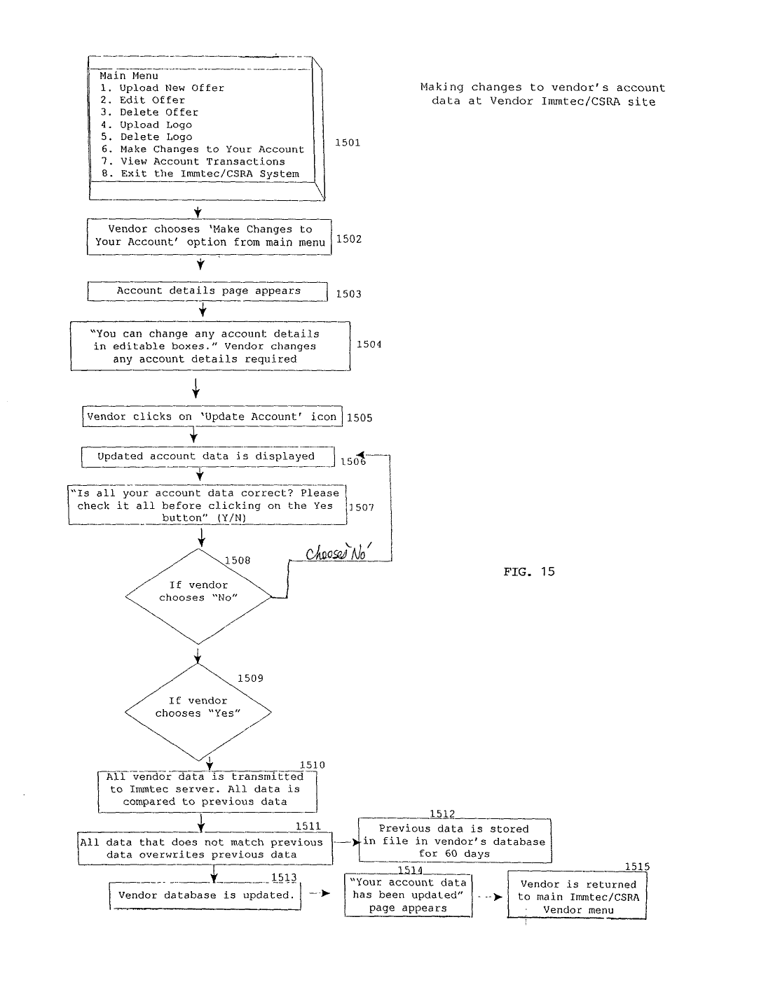

If vendor chooses to ‘Make changes to your account’ option 1502 (as depicted in FIG. 15 as the process would be implemented in an exemplary embodiment of the invention):

a) Account details page appears. 1503

b) All account details are in editable boxes. 1504

c) Vendor can edit any account detail except access codes or account number by typing in the edits on the web page. 1504

d) When editing is complete.

e) Vendor clicks on ‘Update Account’ button. 1505

f) New account data page is displayed. 1506

g) Vendor is asked on page, “Is all this account data correct? Please look it over before clicking on the Update button” (Y/N) buttons. 1507

h) If vendor clicks on the ‘No’ button. 1508

i) The vendor account data editing page appears. 1506

j) If vendor clicks on the ‘Yes’ button: 1509

k) All data on account details page is transmitted to Immtec/CSRA vendor's database. All data is compared with previous account data. 1510

l) All data that does not match previous data overwrites previous data. 1511-1512

m) Vendor's account data is updated. 1513

n) “Your account data has been successfully updated” page appears. 1514

o) Immtec/CSRA main menu page appears. 1515

8. View Account Transactions

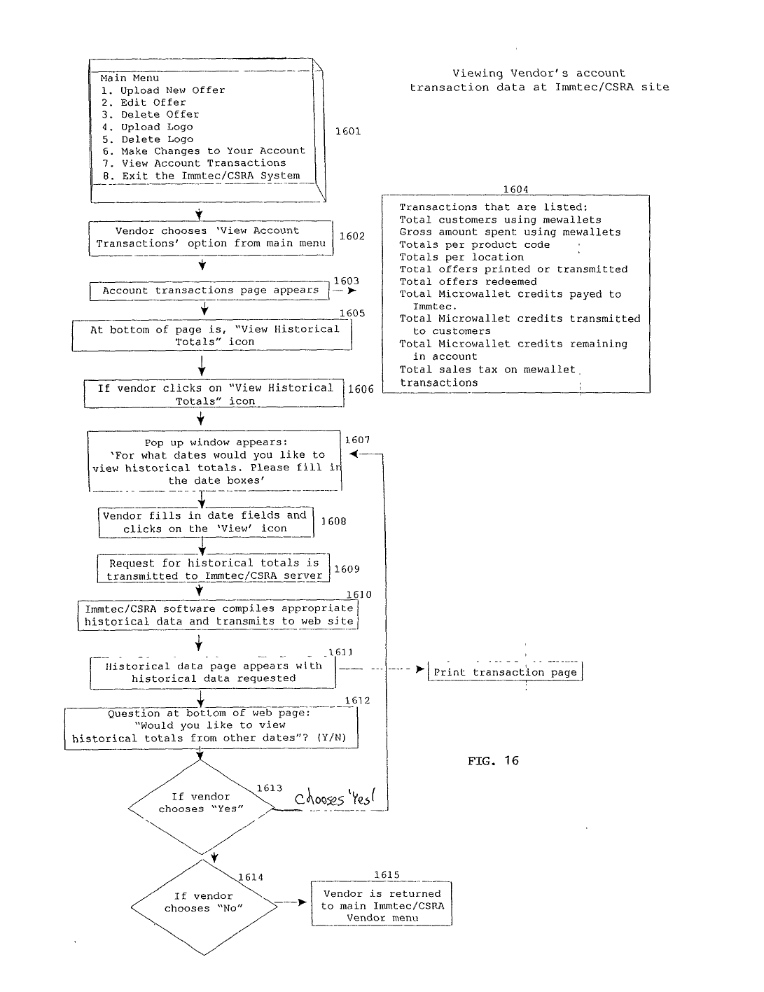

If ‘View Account Transactions’ option is chosen 1602 (as depicted in FIG. 16 as the process would be implemented in an exemplary embodiment of the invention):

a) Account transaction page is displayed. 1603

b) Transactions displayed include: 1604 Total customers using mewallets, gross amount spent using mewallets, totals per product code, totals per location, total offers printed or transmitted, total offer coupons redeemed, total Microwallet credits transmitted, total Microwallet credits payed to Immtec, total Microwallet credits remaining in account.

c) At bottom of page is a ‘View historical totals’ button. 1605

d) If vendor clicks on ‘View historical totals’ button: 1606

e) Historical totals request page appears. 1607

f) ‘For what period would you like to see historical totals? Please fill in the dates in the boxes’ question is asked on page. 1607

g) Vendor fills in the appropriate dates in the boxes on the page and clicks the ‘View’ button. 1608

h) Request for historical totals for vendor's account is transmitted to Immtec/CSRA database. 1609

i) Immtec/CSRA software compiles appropriate historical data for vendor's account. 1610

j) Immtec/CSRA transmits historical data to web page.

k) Historical data page appears with historical data for requested dates. 1611

l) ‘Would you like to see historical totals from other dates?’ Question is at bottom of page (Y/N). 1612

m) If vendor clicks on the ‘Yes’ button: 1613

n) Historical totals request page appears. 1607

o) If vendor clicks on the ‘No’ button: 1614

p) Main Immtec/CSRA menu page appears. 1615

9. Exit the System

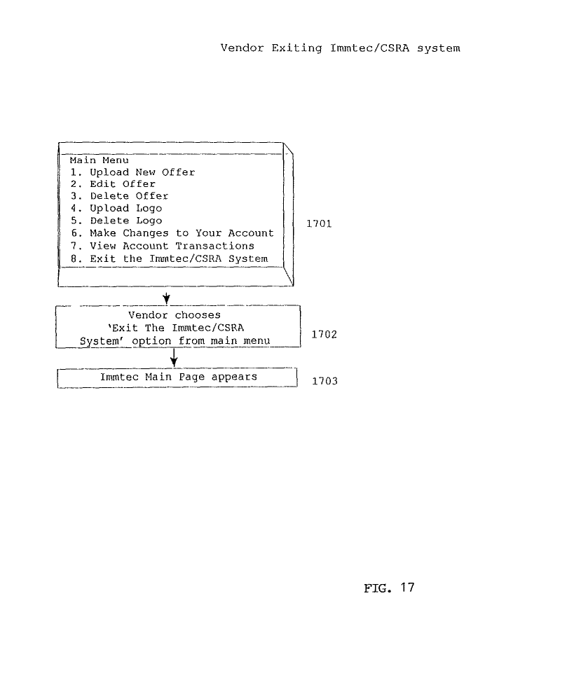

If vendor chooses ‘Exit the System’ option 1702 (as depicted in FIG. 17 as the process would be implemented in an exemplary embodiment of the invention):

a) ‘Thank you, (vendor's name), for using your update system and for being a mewallet™ service provider’ page appears.

b) Vendor exits to Internet. 1703

Uploading Vendor Microwallet Credits

Each vendor has a Microwallet credit account from which Microwallet credits can be sent to customers as incentives and to Immtec as micropayments on transactions. In the exemplary embodiment of the invention, each Vendor would ‘fill’ an account corresponding to that Vendor with an amount of money that the Immtec system, or in the alternative, Immtec system representatives, would calculate to be an approximate amount for 30 days of Microwallet credits. If credits reach a level below an agreed upon amount, Immtec would bill the vendor the amount necessary to ‘fill’ the Microwallet credit account to the agreed-upon amount. Vendor Microwallet credits would be uploaded by Immtec to the vendor's account when Immtec receives payment for the amount needed to ‘fill’ the vendor's Microwallet™ credit account.

When the vendor and Immtec establish a Microwallet™ credit account, certain parameters would be established, including, for example:

a) How much money is kept in the Microwallet credit account.

b) What is the minimum amount of money needed in the Microwallet credit account.

c) Form of payment to Immtec for the Microwallet credit account.

d) Distribution of Microwallet credits to customers:

1. How many per amount customer spends

2. Special incentive offers

3. Time frames for special incentive offers

4. Offers involving vendor's alliance partners

e) Percentage of micropayments to Immtec for mewallet™ sales.

Transmitting Offer to POS Printer

When a customer makes a payment for a purchase or service through a POS device, the credit card, bank account or debit card data is transmitted to a clearinghouse for approval. If the customer is using an Immtec mewallet™ enabled device for the transaction, the following data would also be transmitted to the Immtec database:

1. Security & identity data for approval

2. Ticket redemption data for approval

3. Purchase data

4. Location data

5. vendor data

6. Microwallet level data

7. micropayment from Microwallet

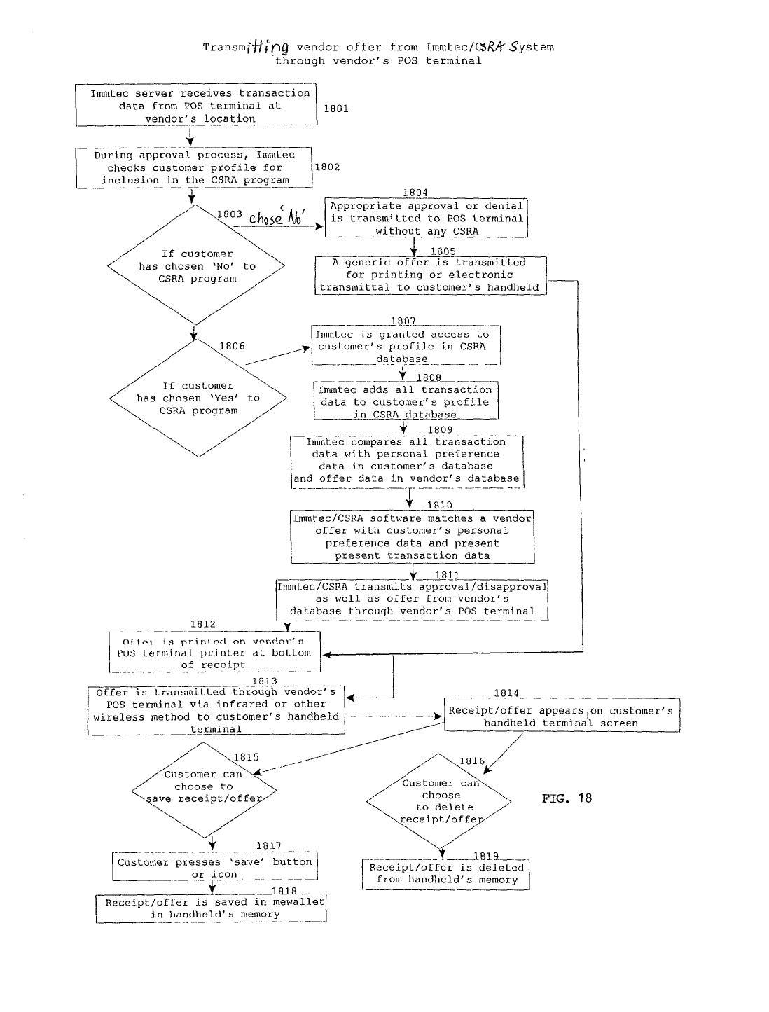

The process for transmitting a vendor's offer through the POS device to the vendor's receipt printer is described below as would be implemented in the exemplary embodiment and as is depicted in FIG. 18:

a) Immtec server receives transaction data from POS terminal at vendor's location. 1801

b) During approval process, Immtec software checks customer profile for inclusion in the CSRA program. 1802

c) If Immtec software detects a ‘No’ answer to customer's inclusion in the CSRA program: 1803

d) Then appropriate approval or denial is transmitted to POS terminal without any customer specific advertising. 1804

e) A generic ad from vendor's database is transmitted for printing with customer's receipt from vendor's receipt printing device. 1805,1812-1818

f) If Immtec software detects a ‘Yes’ answer to customer's inclusion in the CSRA program: 1806

g) Immtec is granted access to customer's profile in the CSRA database. 1807

h) Immtec adds present location, time and all purchase data to customer's CSRA database file. 1808

i) Immtec compares present location, time and all purchase data with personal preference data in customer's database and offer data in vendor's database. 1809

j) Immtec/CSRA software matches a vendor or alliance partner offer to customer's personal preferences. 1810

k) Immtec/CSRA transmits approval/disapproval as well as offer from vendor's database attached to receipt through vendor's POS terminal. 1811

l) Vendor's offer print's on customer's printed receipt from vendor's receipt printer. 1812

m) and/or

n) Immtec/CSRA transmits offer is transmitted from vendor's database through vendor's POS device to customer's handheld via infrared or other wireless method. 1813

o) Receipt and offer appear on customer's handheld screen. 1814

p) Customer can choose to save receipt and offer or delete them.

q) If customer chooses to delete receipt/offer: 1816

r) Customer presses the ‘delete’ button or icon on handheld.

s) Receipt/offer is deleted from memory. 1819

t) If customer chooses to ‘save’ receipt/offer: 1815

u) Customer presses the ‘save’ button or icon. 1817

v) Receipt/offer is saved in mewallet™ in handheld's memory. 1818

Transmitting Micropayment Credits from Vendor's Microwallet Credit Account

Microwallet micropayment credits are electronic money credits that would be saved in the vendor's Microwallet credit account on the Immtec/CSRA servers. Funds for the vendor's Microwallet credit account would be save in Immtec's bank account. Microwallet micropayment credits would be transmitted to the vendor's customers during mewallet™ transactions according to the parameters established by the vendor. Customer must be signed-up for the CSRA program to receive Microwallet micropayment credits.

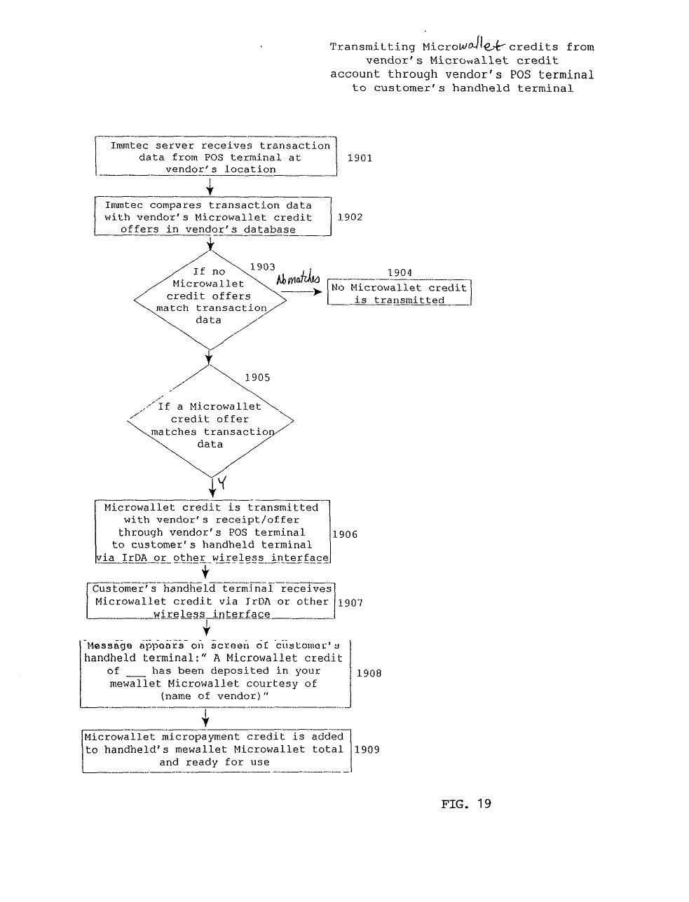

The process for transmitting a vendor's Microwallet micropayment credit through the POS device to the customer's handheld device as the process would be implemented in the exemplary embodiment of the invention is described below and is depicted in FIG. 19:

a) Mewallet™ transaction data is transmitted via infrared or other wireless method through vendor's POS device to clearinghouse and Immtec. 1901

b) Immtec compares transaction data with Microwallet micropayment credit offers in location's (vendor's) database. 1902

c) If Microwallet micropayment credit offer does not matches transaction data. 1903

d) No micropayment credit is transmitted. 1904

e) If Microwallet micropayment credit offer matches transaction data. 1905

f) Microwallet micropayment credit is transmitted with vendor's receipt/offer through vendor's POS device to customer's handheld via infrared or other wireless method. 1906

g) Customer receives Microwallet micropayment credit in handheld via infrared or other wireless method. 1907

h) Message appears on screen of handheld, “A Microwallet micropayment credit of has been deposited in your mewallet™ Microwallet courtesy of (name) vendor”. 1908

i) Microwallet micropayment credit is received into the customer's mewallet™ Microwallet.

j) Microwallet micropayment credit is added to customer's mewallet™ Microwallet total and ready for use. 1909

Redeeming Vendor's Offers by Customer Using Mewallet™ Enabled Handheld for Offers Requiring Approval

An offer printed on the customer's receipt would be redeemed in a manner similar to the way in which a traditional hardcopy paper coupon offer is redeemed with a vendor. An offer held electronically in the mewallet in the handheld device would be redeemed electronically at the vendor's location whether in a physical location or an Internet location. Some offers will require approval to be redeemed as prescribed by offering vendor. Some offers will not require approval.

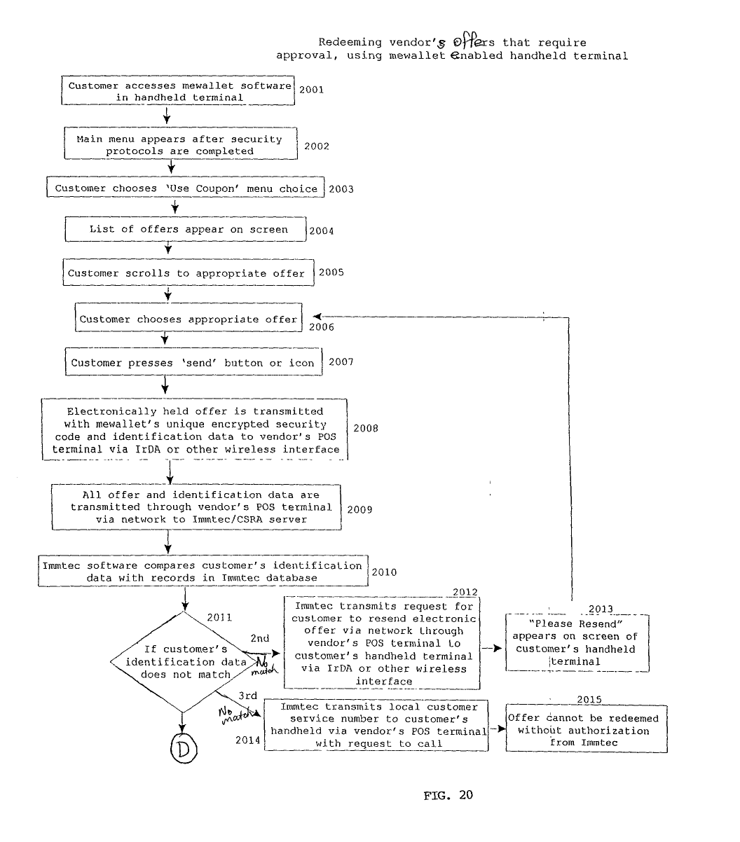

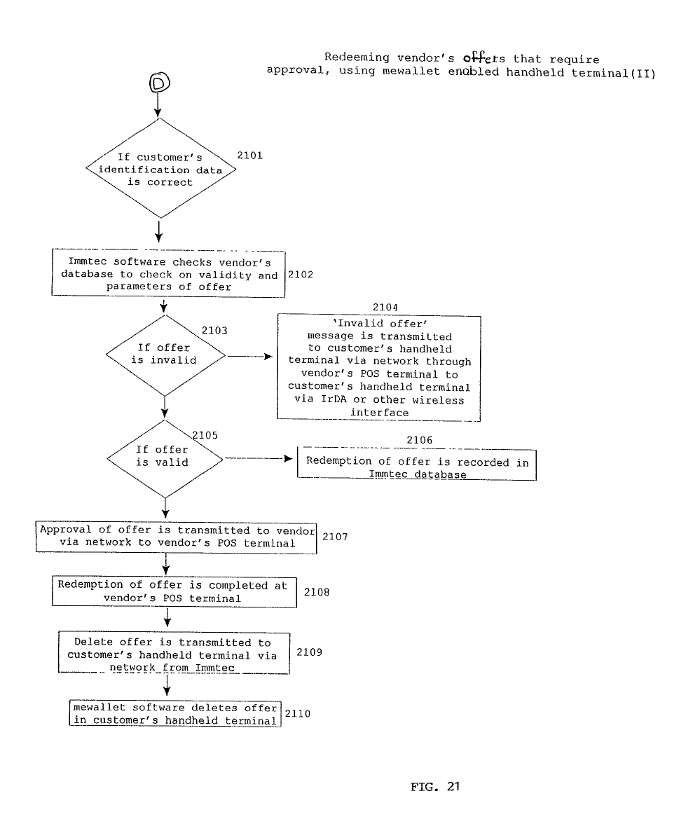

The process for electronically redeeming a vendor's offer that requires approval, from the customer's handheld device, as the process would be implemented in the exemplary embodiment of the invention is described below and is depicted in FIGS. 20-21:

a) Customer accesses the mewallet™ software in their handheld device. 2001

b) Main menu appears after security protocols are passed. 2002

c) Customer chooses ‘use coupon’ menu choice. 2003

d) List of offers appear on screen of handheld, (customer can scroll down/up to see all choices). 2004

e) Customer scrolls to appropriate coupon/offer. 2005

f) With coupon/offer chosen on screen customer presses ‘send’ icon or button. 2006-2007

g) Electronically held offer is transmitted with customer's unique, encrypted security code and identification data to vendor's POS terminal via IrDA or other local wireless method. 2008

h) Customer's electronically transmitted offer and unique encrypted security code and identification data are transmitted through vendor's POS terminal to Immtec/CSRA database.

i) Immtec software compares customer's identification data with records in database. 2010

j) If customer's identification data does not match and is incorrect: 2011

k) Immtec sends request for customer to resend electronic offer through vendor's POS terminal to customer's handheld. 2012

l) Customer sees resend on screen of handheld and presses ‘send’ button or icon. 2013

m) Customer's electronically transmitted offer and unique encrypted security code and identification data are transmitted through vendor's POS terminal to Immtec/CSRA database. 2008

n) Immtec software compares customer's identification data with records in database. 2010

o) If customer's identification data does not match and is incorrect: 2011

p) Immtec transmits local customer service number to customer's handheld via vendor's POS terminal with request to call. 2014

q) Offer cannot be used without approval from Immtec. 2015

r) If customer's identification data is correct: 2101

s) Immtec software checks vendor's database to check on validity and parameters of offer, (time, location, if offer is in vendor's database). 2102

t) If offer is not a valid offer or time has expired: 2103

u) Invalidity is transmitted to customer's handheld device via vendor's POS terminal. 2104

v) If offer is valid: 2105

w) Redemption of vendor offer is recorded in Immtec's database. 2106

x) Approval for electronic offer is transmitted to vendor via POS terminal. 2107

y) Redemption of offer is completed on vendor's POS terminal. 2108

z) Delete offer is transmitted to customer's handheld terminal via network from Immtec. 2019

aa) mewallet™ software deletes offer in customer's handheld terminal. 2110

Redeeming Vendor's Offers by Customer Using Mewallet™ Enabled Handheld for Offers not Requiring Approval

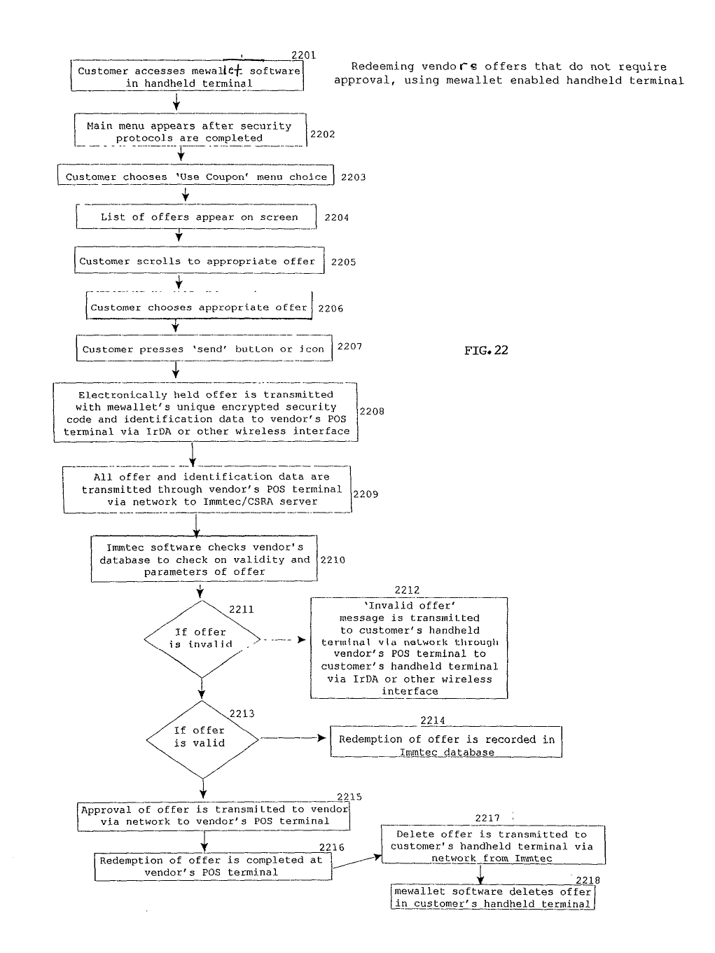

Some vendor offers do not require approval. For such no-approval-required offers, the process for electronically redeeming a vendor's offer from the customer's handheld device is described below as the process would be implemented in the exemplary embodiment of the invention and is depicted in FIG. 22:

a) Customer accesses the mewallet™ software in their handheld terminal. 2201

b) Main menu appears after security protocols are passed. 2202

c) Customer chooses ‘use coupon’ menu choice. 2203

d) List of coupons appear on screen of handheld, (customer can scroll down/up to see all choices). 2204

e) Customer scrolls to appropriate coupon/offer. 2205

f) With coupon/offer chosen on screen customer presses ‘send’ icon or button. 2206-2207

g) Electronically held offer is transmitted with customer's unique, encrypted security code and identification data to vendor's POS terminal via IrDA or other local wireless method. 2208

h) Customer's electronically transmitted offer and unique encrypted security code and identification data are transmitted through vendor's POS terminal to Immtec/CSRA database. 2209

i) Immtec software checks vendor's database to check on validity and parameters of offer, (time, location, if offer is in vendor's database). 2210

j) If offer is not valid or time has expired: 2211

k) Invalidity of offer is transmitted to customer's handheld device via vendor's POS terminal. 2212

l) If offer is valid: 2213

m) Redemption of vendor offer is recorded in Immtec's database. 2214

n) Approval for electronic offer is transmitted to vendor via POS terminal. 2215

o) Redemption of offer is completed on vendor's POS terminal. 2216

p) Delete offer is transmitted to customer's handheld terminal via network from Immtec. 2217

q) mewallet™ software deletes offer in customer's handheld terminal. 2218

Mewallet™ Customer Accesses Vendor Offer Database upon Entering Vendor's Location via IrDA or Other Wireless Method.

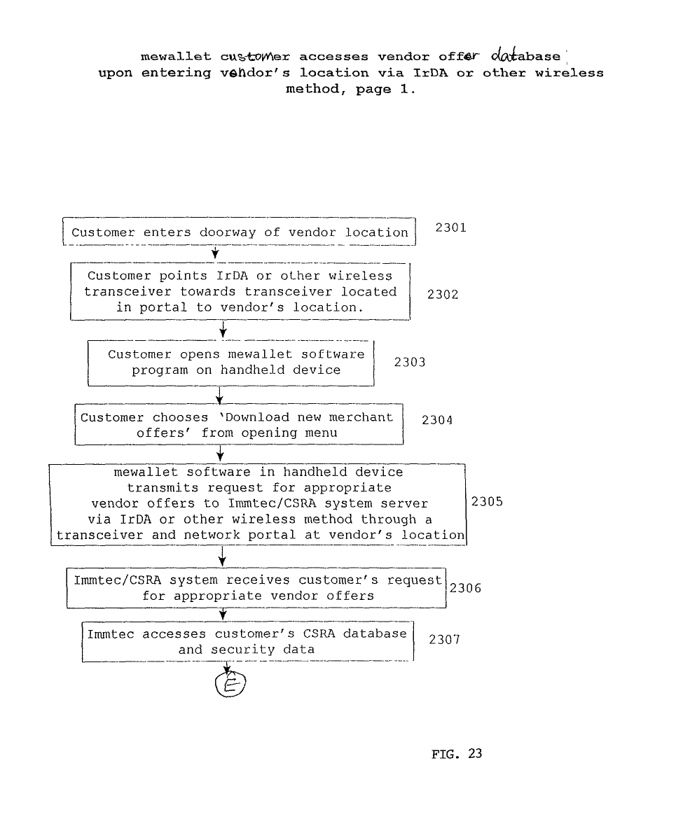

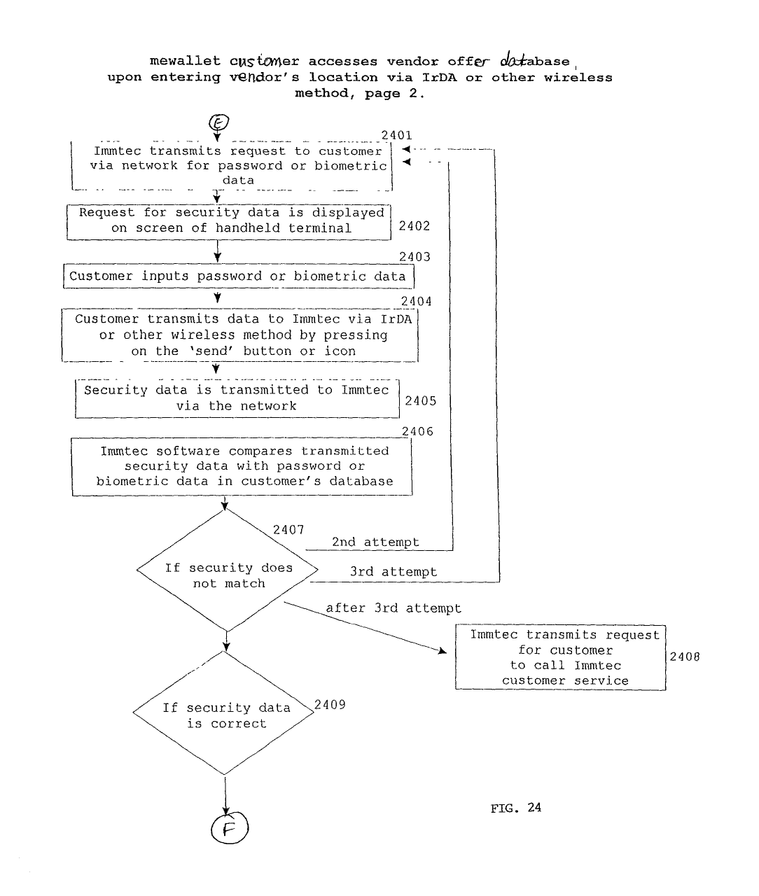

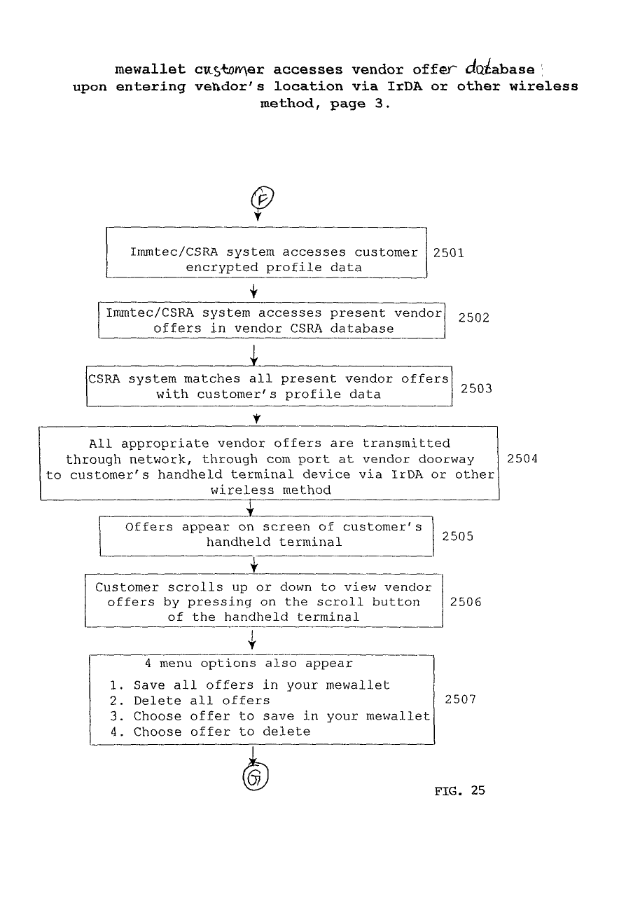

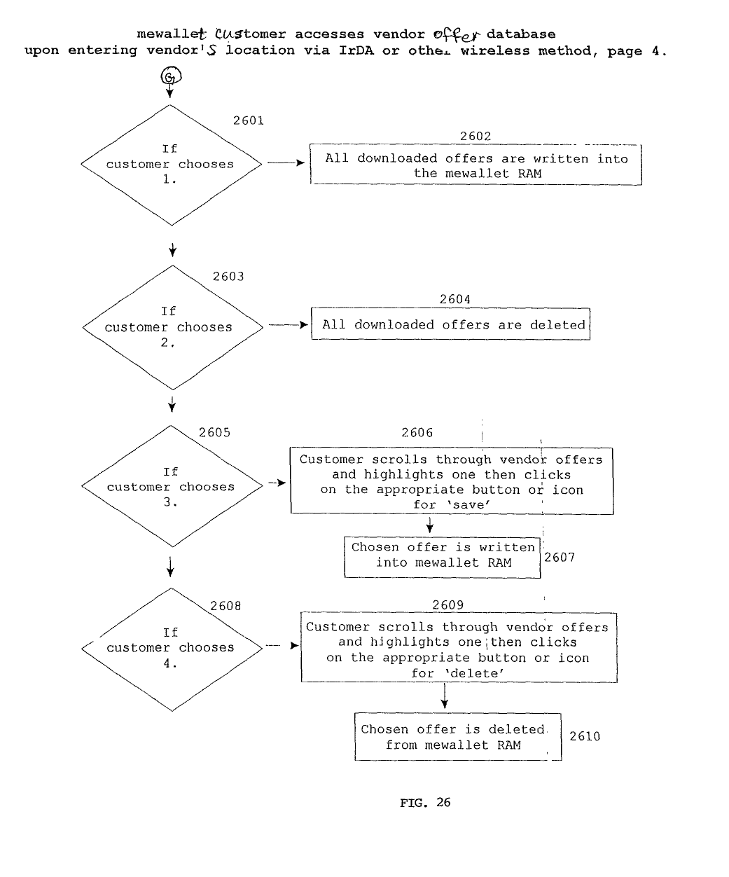

A doorway feature would be implemented in the exemplary embodiment of the invention such that when a customer who has signed up for CSRA program enters a vendor's location, the customer has the option of focusing an IrDA or other wireless transceiver on their handheld terminal at a transceiver at a portal in the vendor's location. After establishing communication between the two transceivers, the customer could download all vendor offers that are applicable to the customer's profile and date of entering the vendor's location. This vendor offer data could also be downloaded into the customer's handheld terminal via wireless Internet communication if the handheld terminal is wireless Internet capable. In the exemplary embodiment, ‘store’ refers to any vendor location. The process of downloading vendor offers and redeeming those offers at a vendor's store portal is described below as the process would be implemented in the exemplary embodiment and is depicted in FIGS. 23-26.

a) Customer enters doorway of vendor's location. 2301

b) Customer points IrDA or other wireless transceiver towards transceiver located in portal to vendor's store. 2302

c) Customer opens mewallet™ software program on handheld device. 2303

d) Customer chooses ‘Download new merchant offers’ from opening menu. 2304

e) mewallet™ software in handheld device transmits request for appropriate vendor offers to Immtec/CSRA system via IrDA or other wireless method through communication port at vendor's location. 2305

f) The mewallet™'s transmission includes the customer's unique encrypted security code. Immtec accesses customer's encrypted CSRA database and security data. 2307

g) The Immtec/CSRA system receives customer's request for appropriate vendor offers. 2306

h) Immtec transmits request for customer's password or biometric data. 2401

i) Request for security data is displayed on screen of customer's handheld device. 2402

j) Customer inputs password or biometric data. 2403

k) Customer transmits data to Immtec by pressing on the ‘send’ button or icon. 2404

l) Security data is transmitted to Immtec's server via wireless connection through network. 2405

m) Immtec server software compares transmitted security data with password or biometric data in customer's database. 2406

n) If security data does not match. 2407

o) Immtec transmits request for customer's password or biometric data. 2401

p) A second request for security data is displayed on screen of customer's handheld device. 2402

q) Customer inputs password or biometric data. 2403

r) Customer transmits data to Immtec by pressing on the ‘send’ button or icon. 2404

s) Security data is transmitted to Immtec's server via wireless connection through Immtec's Internet portal. 2405

t) Immtec server software compares transmitted security data with password or biometric data in customer's database. 2406

u) If security data does not match: 2407

v) A third request is transmitted for security data to customer's handheld device.

w) If on the third attempt the security data is incorrect:

x) Immtec transmits request for customer to call Immtec customer service. 2408

y) Request for customer to call Immtec customer service is displayed on screen of handheld device.

z) If security data is correct. 2409

aa) The Immtec/CSRA system accesses customer's encrypted profile data. 2501

bb) The Immtec/CSRA system accesses vendor's present offers in vendor's CSRA database. 2502

cc) The Immtec/CSRA system matches all present vendor offers with customer's profile data. 2503

dd) All offers that match customer's profile data are transmitted through the communication port at vendor's location portal to customer's handheld device via IrDA or other wireless method. 2504

ee) All appropriate vendor offers appear as a list on screen of customer's handheld terminal. 2505

ff) Customer scrolls up or down to view vendor offers by pressing on the scroll button on the handheld terminal. 2506

gg) User has 4 menu options that appear on handheld terminal screen: 2507

1. Save all offers in your mewallet™

2. Delete all offers

3. Choose offer to save in your mewallet™

4. Choose offer to delete

hh) If customer chooses 1: 2601

ii) All downloaded offers are written into the mewallet™ memory and stored. 2602

jj) If customer chooses 2: 2603

kk) All downloaded offers are deleted from the mewallet™ RAM. 2604

ll) If customer chooses 3: 2605

mm) Customer scrolls through vendor offers and highlights one then clicks or pushes on the appropriate button or icon for ‘save’. 2606

nn) Chosen offer is then written into the mewallet™ memory and stored. 2607

oo) If customer chooses 4: 2608

pp) Customer scrolls through vendor offers and highlights one then clicks or pushes on the appropriate button or icon for ‘delete’. 2609

qq) Vendor offer is then deleted from the mewallet™ RAM. 2610

Mewallet™ Customer Accesses Vendor Offer Database via Wireless Internet Capable Handheld Device.

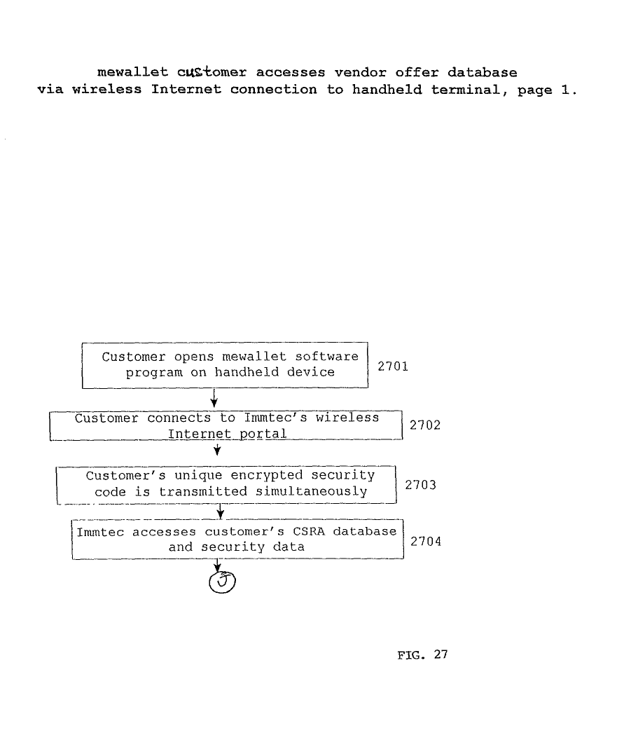

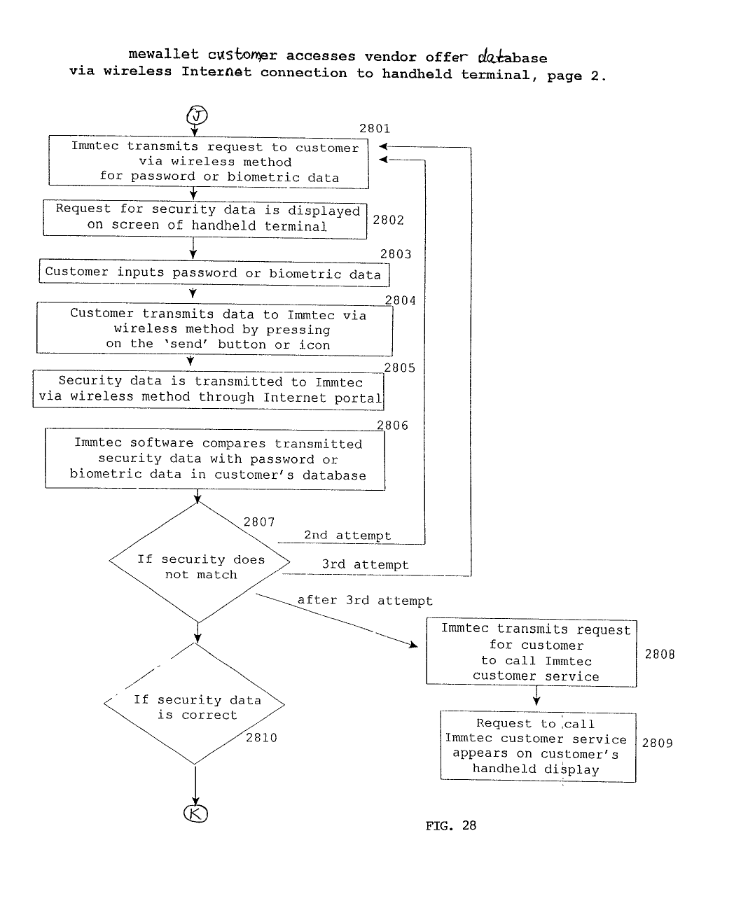

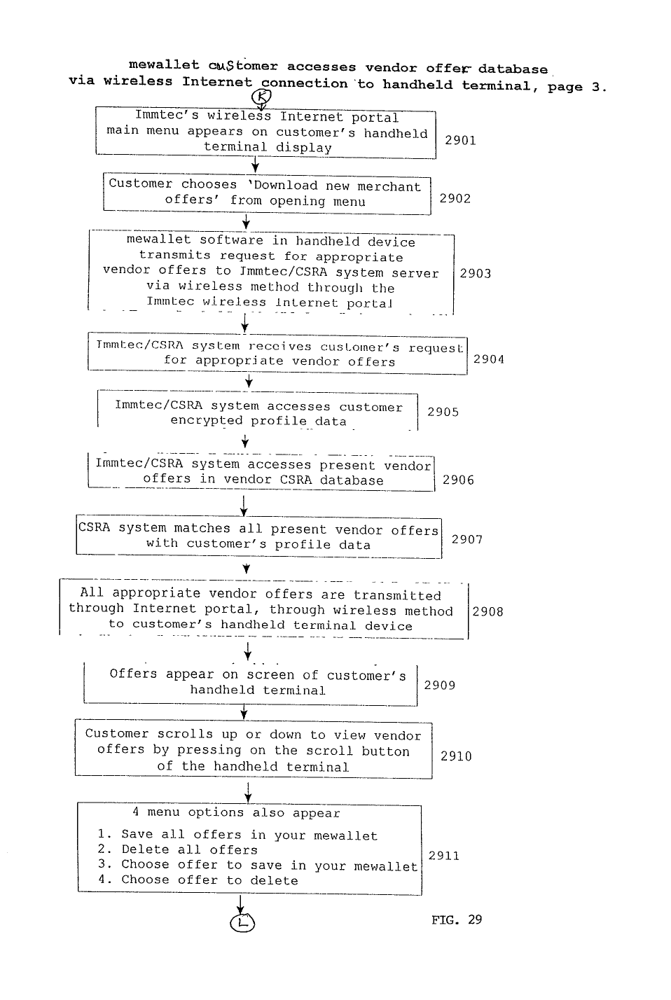

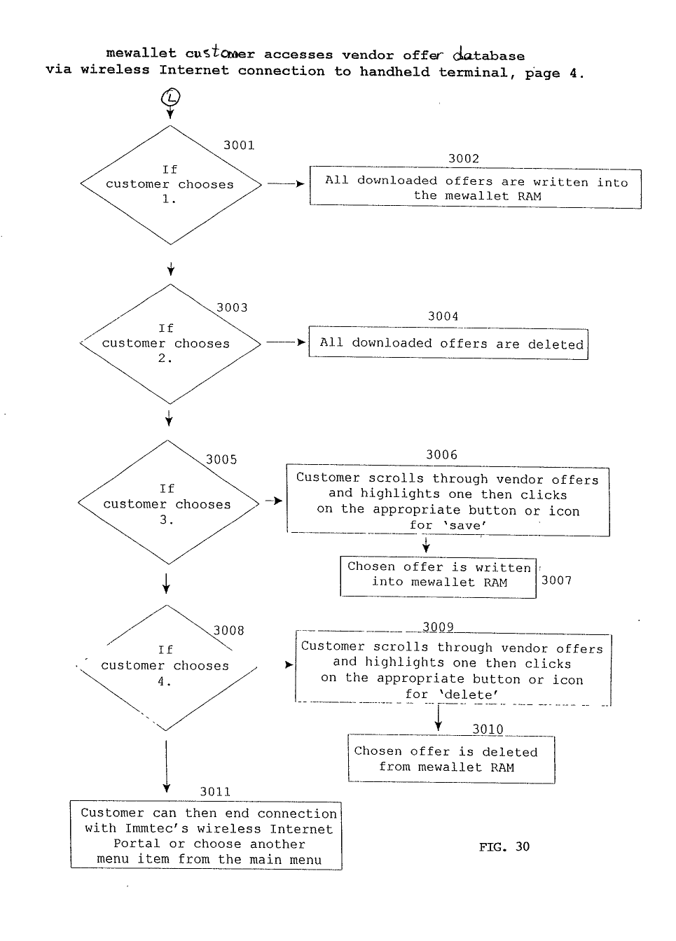

A wireless vendor offer access feature would be implemented in the exemplary embodiment of the invention such that the mewallet™ system in a handheld terminal would be capable of downloading and storing vendor offers from the Internet utilizing any wireless Internet protocol through which the handheld terminal is capable of wireless Internet connectivity. The process for downloading and redeeming vendor offers from the Internet with the mewallet™ system is described below as it would be implemented in the exemplary embodiment and is depicted in FIGS. 27-30.

a) Customer opens mewallet software program on handheld device. 2701

b) Customer connects to Immtec's wireless Internet portal via handheld device. 2702

c) Customer's mewallet™ unique encrypted security code is transmitted simultaneously. 2703

d) Immtec server accesses customer's CSRA database and security data. 2704

e) Immtec transmits request for customer's password or biometric data. 2801

f) Request for security data is displayed on screen of customer's handheld device. 2802

g) Customer inputs password or biometric data. 2803

h) Customer transmits data to Immtec by pressing on the ‘send’ button or icon. 2804

i) Security data is transmitted to Immtec's server via wireless connection through Immtec's Internet portal. 2805

j) Immtec server software compares transmitted security data with password or biometric data in customer's database. 2806

k) If security data does not match. 2807

l) Immtec transmits request for customer's password or biometric data. 2801

m) A second request for security data is displayed on screen of customer's handheld device. 2802

n) Customer inputs password or biometric data. 2803

o) Customer transmits data to Immtec by pressing on the ‘send’ button or icon. 2804

p) Security data is transmitted to Immtec's server via wireless connection through Immtec's Internet portal. 2805

q) Immtec server software compares transmitted security data with password or biometric data in customer's database. 2806

r) If security data does not match: 2807

s) A third request is transmitted for security data to customer's handheld device. 2801

t) If on the third attempt the security data is incorrect:

u) Immtec transmits request for customer to call Immtec customer service. 2808

v) Request for customer to call Immtec customer service is displayed on screen of handheld device. 2809

w) If security data is correct: 2810

x) Immtec's wireless Internet portal menu is displayed on screen of handheld device. 2901

y) Customer scrolls to menu option; ‘Download Merchant offers’ then clicks on ‘send’. 2902

z) ‘Download Merchant offers’ request is transmitted to Immtec/CSRA server via wireless Internet portal. 2903

aa) New menu is transmitted to customer's handheld and appears on screen.

bb) “Please say or type in the merchant name you would like to download offers for”, appears on customer's handheld screen.

cc) If customer's handheld device supports audio transmission then customer can say the name of the merchant.

dd) The audio data is transmitted to the Immtec/CSRA server's vocal recognition system and translated into binary data and transmitted to the Immtec/CSRA system. 2904

ee) If customer types in the merchant name and presses ‘send’.

ff) Merchant name is transmitted to Immtec/CSRA system. 2904

gg) Immtec/CSRA system matches customer's preference data with chosen vendor offers. 2907

hh) Filtered offers are transmitted via Immtec/CSRA wireless Internet portal to customer's handheld device. 2908

ii) Merchant offers appear on screen of user's handheld device. 2909

jj) Customer scrolls up or down to view vendor offers by pressing on the scroll button of the handheld terminal. 2910

kk) Customer also has 4 options that appear: 2911

1. Save all offers in your mewallet™

2. Delete all offers

3. Choose offer to save in your mewallet™

4. Choose offer to delete

ll) If customer chooses 1: 3001

mm) All downloaded offers are written into the mewallet™ memory and stored. 3002

nn) If customer chooses 2: 3003

oo) All downloaded offers are deleted from the mewallet™ RAM. 3004

pp) If customer chooses 3: 3005

qq) Customer scrolls through vendor offers and highlights one then clicks or pushes on the appropriate button or icon for ‘save’. 3006

rr) Chosen offer is then written into the mewallet™ memory and stored. 3007

ss) If customer chooses 4: 3008

tt) Customer scrolls through vendor offers and highlights one then clicks or pushes on the appropriate button or icon for ‘delete’. 3009

uu) Vendor offer is then deleted from the mewallet™ RAM. 3010

vv) Appropriate offers are now ready for redemption.

ww) Customer can then end wireless Internet connection with Immtec's wireless Internet portal or choose another menu item from the main menu. 3011

Mewallet™ Customer Accesses Vendor Offer Database at an Interactive Billboard, Kiosk or Other out of Home Advertising Medium via IrDA or Other Wireless Method.

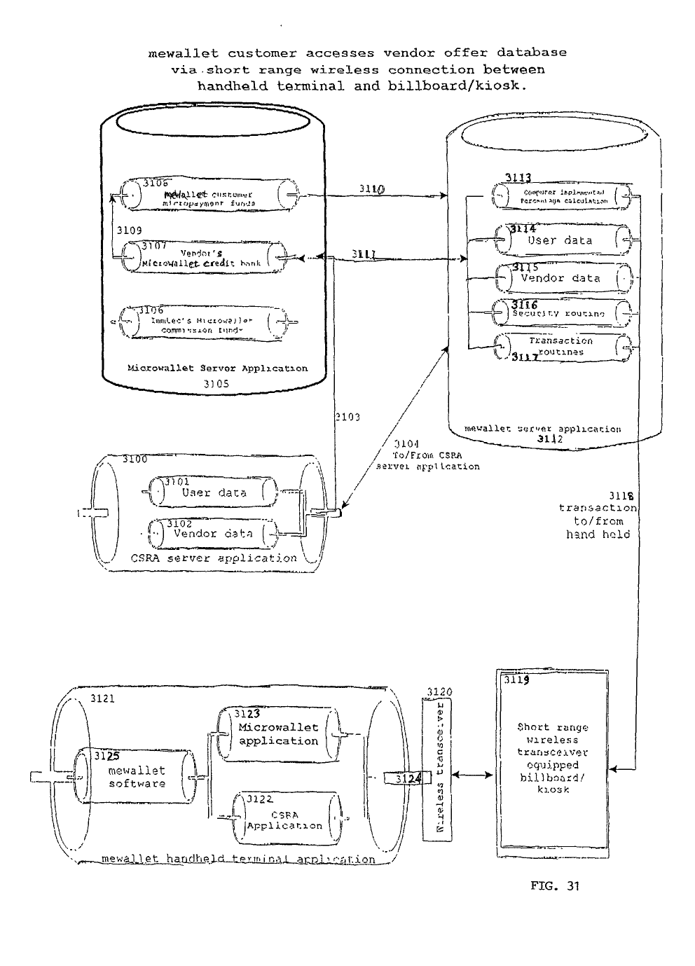

An interactive billboard/kiosk feature would be implemented in the exemplary embodiment of the invention such that when a customer who has signed up for CSRA program passes by a billboard, kiosk or other out-of-home advertising medium equipped with a local wireless interface such as IrDA or short range radio transceiver, the customer would have the option of focusing the IrDA or other wireless transceiver on their handheld terminal at a transceiver at the local wireless equipped billboard, kiosk or other out-of-home advertising medium. After establishing communication between the two transceivers, the customer would download all vendor offers (including Microwallet™ credits), which are applicable to the customer's profile and date of offers. In the exemplary embodiment, ‘store’ refers to any vendor location and “billboard”/“kiosk” refers to any out of home advertising medium. (The security data request procedure is optional.) The process of downloading vendor offers from a billboard/kiosk is described below as the process would be implemented in the exemplary embodiment and is the same as is depicted in FIGS. 23-26, and 28 except for the difference in location of the short-range wireless interface (reference is also made to FIG. 31). (Billboard/kiosk rather than vendor portal.):

a) Customer stops at billboard/kiosk. 3119,2301

b) Customer points IrDA or other wireless transceiver 3120 towards transceiver located in billboard/kiosk 3119.

c) Customer opens mewallet™ software program 3125 on handheld device.

d) Customer chooses ‘Download new merchant offers’ from opening menu.

e) mewallet™ software 3125,3123 in handheld device transmits request for appropriate vendor offers to Immtec/CSRA system 3112, 3100 via IrDA or other wireless method through communication port at billboard/kiosk 3119.

f) The mewallet™'s transmission includes the customer's unique encrypted security code. Immtec accesses customer's encrypted CSRA database 3100-3102, 3104 and security data 3114,3116.

g) The Immtec/CSRA system receives customer's request for appropriate vendor offers 3118.

h) Immtec transmits request for customer's password or biometric data 3116,3118.

i) Request for security data is displayed on screen of customer's handheld device.

j) Customer inputs password or biometric data.

k) Customer transmits data to Immtec by pressing on the ‘send’ button or icon.

l) Security data is transmitted to Immtec's server via wireless connection through network. 2405, 3118, 3116.

m) Immtec server software compares transmitted security data with password or biometric data in customer's database 3116, 3114.

n) If security data does not match.

o) Immtec transmits request for customer's password or biometric data.

p) A second request for security data is displayed on screen of customer's handheld device.

q) Customer inputs password or biometric data.

r) Customer transmits data to Immtec by pressing on the ‘send’ button or icon.

s) Security data is transmitted to Immtec's server via wireless connection through Immtec's Internet portal.

t) Immtec server software compares transmitted security data with password or biometric data in customer's database.

u) If security data does not match:

v) A third request is transmitted for security data to customer's handheld device.

w) If on the third attempt the security data is incorrect:

x) Immtec transmits request for customer to call Immtec customer service.

y) Request for customer to call Immtec customer service is displayed on screen of handheld device.

z) If security data is correct.

aa) The Immtec/CSRA system accesses customer's encrypted profile data 3104, 3114,3100,3101.

bb) The Immtec/CSRA system accesses vendor's present offers in vendor's CSRA database 3115,3102,3104.

cc) The Immtec/CSRA system matches all present vendor offers with customer's profile data, 3101-3102.

1. All offers are transmitted from Immtec/CSRA/Microwallet™ servers to communication port in billboard/kiosk, 3111,3104,3118

dd) All offers that match customer's profile data are transmitted through the communication port in billboard/kiosk to customer's handheld device via IrDA or other wireless method. 2504, 3119, 3120, 3124, 3122, 3123

ee) All appropriate vendor offers appear as a list on screen of customer's handheld terminal. 2505, 3125

ff) Customer scrolls up or down to view vendor offers by pressing on the scroll button on the handheld terminal. 2506, 3121

gg) User has 4 menu options that appear on handheld terminal screen: 2507, 3125

1. Save all offers in your mewallet™

2. Delete all offers

3. Choose offer to save in your mewallet™

4. Choose offer to delete

hh) If customer chooses 1: 2601

ii) All downloaded offers are written into the mewallet™ memory and stored. 2602

jj) If customer chooses 2: 2603

kk) All downloaded offers are deleted from the mewallet™ RAM. 2604

ll) If customer chooses 3: 2605

mm) Customer scrolls through vendor offers and highlights one then clicks or pushes on the appropriate button or icon for ‘save’. 2606

nn) Chosen offer is then written into the mewallet™ memory and stored. 2607

oo) If customer chooses 4: 2608

pp) Customer scrolls through vendor offers and highlights one then clicks or pushes on the appropriate button or icon for ‘delete’. 2609

qq) Vendor offer is then deleted from the mewallet™ RAM. 2610, 3121, 3125

Illustrative Embodiments

Although this invention has been described in certain specific embodiments, many additional modifications and variations would be apparent to those skilled in the art. For example, reference herein to the “Immtec” system and to “Immtec” servers are exemplary references to a system for processing the information and for performing the functions herein described and to server computers on which such a system is operable; such references are not a limitation of the invention. It is, therefore, to be understood that this invention may be practiced otherwise than as specifically described. Thus, the embodiments of the invention described herein should be considered in all respects as illustrative and not restrictive, the scope of the invention to be determined by the appended claims and their equivalents rather than the foregoing description.

What is claimed is:

1. A computer-implemented method for providing customer specific receipt promotional offers, said method comprising:
storing customer-specific preferences for each participating customer in a database;
correlating vendor-specified promotional offers for a particular vendor to a particular participating customer's customer-specific preferences; and
communicating one or more vendor-specified promotional offers for the particular vendor to the particular participating customer.

2. The computer-implemented method of claim 1, wherein said communication is performed in response to the particular participating customer making a purchase from the particular vendor.

3. The computer-implemented method of claim 1, wherein said communication is performed in response to the particular participating customer using a hand-held wireless device to communicate a request for available promotional offers.

4. The computer-implemented method of claim 1, wherein said communication is a printed promotional offer.

5. The computer-implemented method of claim 1, wherein said communication is a transmission of an electronically redeemable promotional offer to a hand held device of the particular participating customer.

6. A wireless hand held device for storing an electronically redeemable promotional offer, said device comprising:
an executable program for receiving an electronically redeemable promotional offer; and
an executable program for storing said electronically redeemable promotional offer in a memory storage device in said wireless hand held device.

7. A wireless hand held device for storing an electronically redeemable promotional offer, said device comprising:
a memory storage device for storing data;
an executable memory;
a microprocessor;
short-range wireless communication hardware; program instructions to support short-range wireless communication;
an executable program for receiving an electronically redeemable promotional offer; and
an executable program for storing said electronically redeemable promotional offer in a memory storage device in said wireless hand held device.

8. A computer-implemented method for storing an electronically redeemable promotional offer, said method comprising:
receiving an electronically redeemable promotional offer; and
storing said electronically redeemable promotional offer in a memory storage device in said wireless hand held device.
